(19) United States
(12) Patent Application Publication
(10) Pub. No.: US 2015/0127389 A1
(43) Pub. Date: May 7, 2015

(54) SYSTEM, METHOD, AND PROGRAM PRODUCT FOR CALCULATING PREMIUMS FOR EMPLOYER-BASED SUPPLEMENTAL UNEMPLOYMENT INSURANCE

(71) Applicant: WAGESECURE, LLC, New York, NY (US)

(72) Inventors: Aaron BLACKMAN, Plainview, NY (US); Gregory S. HALL, Sunset, NC (US)

(21) Appl. No.: 14/534,517

(22) Filed: Nov. 6, 2014

Related U.S. Application Data
(60) Provisional application No. 61/901,077, filed on Nov. 7, 2013.

(51) Int. Cl. G06Q 40/08

(52) U.S. Cl. CPC G06Q 40/08
USPC 705/4

(57) ABSTRACT

A method for providing supplemental unemployment insurance includes receiving, by a computer system, applicant data associated with an applicant for a group unemployment insurance policy that provides supplemental unemployment insurance to one or more beneficiaries. The applicant data includes loss ratio data, application experience data, salary data and waiver selection data. The computer system calculates: state credibility weighted claim rate data and industry credibility claim rate data; expected claim rate data based on the calculated state credibility weighted claim rate data, the calculated industry credibility weighted claim rate data and applicant experience data; claim cost data based at least on the calculated expected claim rate data and the coverage level data; and premium payment data based at least on the calculated claim cost data, loss ratio data, annual salary data and waiver selection data.

### RELATED APPLICATION

This application claims priority to U.S. Provisional Patent Application Ser. No. 61/901,077, filed Nov. 7, 2013 and entitled SYSTEMS AND METHODS FOR PROVIDING GROUP SUPPLEMENTAL UNEMPLOYMENT INSURANCE, the contents of which are incorporated herein by reference in their entirety.

### FIELD

The present invention relates to the field of unemployment insurance and, more particularly, to a system and method for providing a private supplementation of public unemployment insurance (also known as unemployment compensation), including the automated generation of premiums and issuance of policies to employers for the benefit of employees.

### SUMMARY OF THE INVENTION

A system, method, and program product are shown for providing a group insurance product, its pricing, and administration, which provides to a covered employed worker payments to supplement government unemployment insurance. A periodic benefit is paid to the beneficiary (e.g., employee) under the policy in the event that the insured individual suffers a covered loss of employment. In some embodiments, all loss of employment that is covered by state unemployment benefits may be covered by the supplemental insurance after an initial eligibility waiting period. That is, state unemployment eligibility can be used as the determinant of benefit eligibility. In this way, an insurer does not have to maintain its own unemployment validation mechanism but can rely on the state agency that determines eligibility.

In embodiments, group insurance may be made available through an employer, as an employment benefit available for purchase.

In some embodiments, the insured contingency may be a layoff of multiple workers by a common employer, rather than simply an individual losing his or her job.

One aspect of the invention is a method of providing supplemental unemployment insurance. Such method includes issuing to an applicant (e.g., employer) a master insurance policy, which, in exchange for premium payments, entitles the beneficiary or beneficiaries (e.g., employees of the employer-applicant), when unemployed, to receive a periodic financial benefit for a specified time, provided a state government agency responsible for the administration of unemployment claims verifies the beneficiary is entitled to receive unemployment insurance benefits from the state.

Upon receiving from the beneficiary a claim for unemployment benefits and obtaining from the state government agency confirmation that the beneficiary is entitled to receive unemployment insurance benefits from the state, an insurance company may pay to the beneficiary the financial benefit specified according to the policy.

Obtaining from the state government agency the aforesaid confirmation may be performed by a computer system querying a computer system or database of the state agency, receiving a response to said query, and evaluating said response. Paying the beneficiary may be conditioned on the evaluation of the response indicating the beneficiary is entitled to a financial benefit.

In embodiments, benefits may be triggered automatically upon loss of employment without the need for a beneficiary to file a claim. Accordingly, one or more insurance company computers may monitor one or more databases of state unemployment to determine recent additions. Any additions may be cross-checked against a database of covered beneficiaries. For beneficiaries who are unemployed and meeting criteria set forth in their policies, insurance payouts may be provided automatically. In embodiments, such a system may also access one or more employer databases, which may occur before a beneficiary's unemployment began, to determine salary data for use in computing the amount of a policy's benefit.

The financial benefit may be set in the policy to a predetermined portion of the beneficiary's income when employed and measured just prior to becoming unemployed, less said beneficiary's state unemployment insurance benefit. Accordingly, in determining the amounts of the payments to the beneficiary, the benefits actually paid by the state are obtained to verify that a proper amount is paid out. The state unemployment insurance benefit may be accessed by querying a database maintained by the state and/or otherwise populated with state benefit data.

Issuing to an applicant a group insurance policy according to an exemplary embodiment of the present invention may comprise, via a computer system, receiving from the applicant answers to questions about risk factors used in computing the applicant's eligibility for the supplemental unemployment insurance and further receiving a desired amount of potential financial benefit, which amount may be requested and/or received before or after determining the applicant's eligibility; computing the premium if the applicant is eligible; offering to the applicant a group policy specifying a potential financial benefit in the event a claim is submitted, unemployment and eligibility for payment are confirmed, and premium payments are current; and issuing the group policy if the offer is accepted and an initial premium payment is received.

Another aspect of the present invention is the determination of the premium value. The premium determination can account for a state's history in granting and denying unemployment compensation claims, an industry's unemployment history, an employer's history of lay-offs or other instances of unemployment, and various actuarially significant parameters.

A method for providing supplemental unemployment insurance according to an exemplary embodiment of the present invention comprises: receiving, by a computer system, applicant data associated with an applicant for a group unemployment insurance policy that provides supplemental unemployment insurance to one or more beneficiaries, the applicant data comprising at least the following: 1) salary data associated with salary information for each of the one or more beneficiaries; 2) state data associated with state of residence information of the applicant; 3) industry data associated with industry information for the applicant; 4) applicant experience data associated with an experience rating factor for the applicant; 5) coverage level data associated with a coverage level to be provided to each of the one or more beneficiaries; 6) loss ratio data associated with a loss ratio of a provider of the group unemployment insurance policy; 7) waiver selection data associated with a waiver benefit provided to each of the one or more beneficiaries; and 8) annual interest rate data associated with a discount rate; for each of the one or more beneficiaries, calculating, by the computer system, premium payment data using the following algorithm: at least one of accessing or calculating, by the computer system, state relative claim rate data based on the state data; calculating, by the computer system, state credibility factor data based on the at least one of the accessed or calculated state relative claim rate data; calculating, by the computer system, state credibility weighted claim rate data based on the at least one of accessed or calculated state relative claim rate data and the calculated state credibility factor; at least one of accessing or calculating, by the computer system, industry relative claim rate data based on the industry data; calculating, by the computer system, industry credibility factor data based on the at least one of accessed or calculated industry relative claim rate; calculating, by the computer system, industry credibility weighted claim rate data based on the at least one of accessed or calculated industry relative claim rate data and the calculated industry credibility factor; calculating, by the computer system, expected claim rate data based on the calculated state credibility weighted claim rate data, the calculated industry credibility weighted claim rate data and the applicant experience data; calculating, by the computer system, claim cost data based at least on the calculated expected claim rate data and the coverage level data; and calculating, by the computer system, premium payment data based at least on the calculated claim cost data, the loss ratio data, the annual salary data and the waiver selection data; and providing, by the computer system to an applicant computer system, group unemployment insurance policy data comprising the periodic premium payment data.

A system for providing supplemental unemployment insurance according to an exemplary embodiment of the present invention comprises: one or more data processing apparatus; and a non-transitory computer-readable medium coupled to the one or more data processing apparatus having instructions stored thereon which, when executed by the one or more data processing apparatus, cause the one or more data processing apparatus to perform a method comprising: receiving applicant data associated with an applicant for a group unemployment insurance policy that provides supplemental unemployment insurance to one or more beneficiaries, the applicant data comprising at least the following: 1) salary data associated with salary information for each of the one or more beneficiaries; 2) state data associated with state of residence information of the applicant; 3) industry data associated with industry information for the applicant; 4) applicant experience data associated with an experience rating factor for the applicant; 5) coverage level data associated with a coverage level to be provided to each of the one or more beneficiaries; 6) loss ratio data associated with a loss ratio of a provider of the group unemployment insurance policy; 7) waiver selection data associated with a waiver benefit provided to each of the one or more beneficiaries; and 8) annual interest rate data associated with a discount rate; for each of the one or more beneficiaries, calculating premium payment data using the following algorithm: at least one of accessing or calculating state relative claim rate data based on the state data; calculating state credibility factor data based on the at least one of accessed or calculated state relative claim rate data; calculating state credibility weighted claim rate data based on the at least one of accessed or calculated state relative claim rate data and the calculated state credibility factor; at least one of accessing or calculating industry relative claim rate data based on the industry data; calculating industry credibility factor data based on the at least one of the accessed or calculated industry relative claim rate; calculating industry credibility weighted claim rate data based on the at least one of accessed or calculated industry relative claim rate data and the calculated industry credibility factor; calculating expected claim rate data based on the calculated state credibility weighted claim rate data, the calculated industry credibility weighted claim rate data and the applicant experience data; calculating claim cost data based at least on the calculated expected claim rate data and the coverage level data; and calculating premium payment data based at least on the calculated claim cost data, the loss ratio data, the annual salary data and the waiver selection data; and providing, to an applicant computer system, group unemployment insurance policy data comprising the periodic premium payment data.

In an exemplary embodiment, the method further comprises the steps of:
accessing, by the computer system, state claim persistency data and nationwide persistency data;
calculating, by the computer system, state credibility adjusted persistency data based on the calculated state credibility factor and the accessed state persistency data and nationwide persistency data;
calculating, by the computer system, state preliminary average duration data based on the calculated state credibility adjusted persistency;
calculating, by the computer system, projected percentage unemployed data associated with projected percentage of claimants remaining unemployed each claim period over a period of time, based at least on the calculated state credibility adjusted persistency; and
calculating, by the computer system, average loaded duration data based on the calculated projected percentage unemployed data.

In an exemplary embodiment, the method further comprises calculating, by the computer, for each claim period, annuity factor data based on the annual interest rate data.

In an exemplary embodiment, the method further comprises accessing, by the computer system, state benefit data comprising at least one or more of the following: 1) method data associated with a method for calculating a state benefit; 2) low benefit amount data associated with a low benefit amount as a fraction of salary; 3) high benefit amount data associated with a high benefit amount as a fraction of salary; 4) minimum benefit amount data associated with a minimum state benefit amount; and 5) maximum benefit amount data associated with a maximum state benefit amount; calculating, by the computer system, state average fractional benefit data based on the accessed state benefit data; and calculating, by the computer system, state benefit amount data based on the calculated state average fractional benefit data, the annual salary data and the maximum state benefit amount data.

In an exemplary embodiment, the method further comprises calculating, by the computer system, government unemployment contribution amount data based on the calculated state benefit amount data, the annual salary data and the coverage level data.

In an exemplary embodiment, the method further comprises calculating, by the computer system, conversion factor data associated with a conversion factor, based on the annuity factor data, the coverage level data and the calculated government unemployment contribution amount data, wherein the step of calculating, by the computer system, the claim cost data is further based on the calculated conversion factor data.

In an exemplary embodiment, the method further comprises calculating, by the computer system, benefit amount data based on the salary data, the coverage level data and the government unemployment contribution amount data.

In an exemplary embodiment, upon the condition that the waiver selection data indicates that a waiver benefit is applicable, the method further comprises: calculating, by the computer system, additional cost data based on the calculated benefit amount data and the calculated premium payment data; calculating, by the computer system, premium multiplier data based on the additional cost data; and re-calculating, by the computer system, the premium payment data based on the original calculated premium payment data and the premium multiplier.

In an exemplary embodiment, the method further comprises: receiving, by the computer system, request data associated with a request by at least one of the one or more beneficiaries for a supplemental unemployment insurance benefit under the group unemployment insurance policy; and determining, by the computer system, eligibility of the at least one of the one or more beneficiaries for receipt of the supplemental unemployment insurance benefit.

In an exemplary embodiment, the step of determining eligibility is based on whether a state has determined that the at least one of the one or more beneficiaries is eligible for a state unemployment insurance benefit.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIG. 1A is a block diagram illustrating a system for providing individual private unemployment insurance according to an exemplary embodiment of the present invention;

FIG. 1B is a block diagram illustrating a system for providing group private unemployment insurance according to an exemplary embodiment of the present invention;

FIG. 1C is a block diagram illustrating a system for providing group private unemployment insurance according to another exemplary embodiment of the present invention;

FIG. 2 is a block diagram of a computer system of a provider of group private unemployment insurance according to an exemplary embodiment of the present invention;

FIGS. 3A and 3B is a flow chart illustrating method of calculating a premium under a group private unemployment insurance policy according to an exemplary embodiment of the present invention.

FIG. 4 is a flow chart illustrating a method for providing group private unemployment insurance according to an exemplary embodiment of the present invention;

FIG. 5 is a flow chart illustrating a method for processing a claim for group private unemployment insurance according to an exemplary embodiment of the present invention;

FIG. 6 is a flow chart illustrating a method for calculating a premium under a group private unemployment insurance policy according to another exemplary embodiment of the present invention;

FIG. 7 is a flow chart illustrating a method of calculating a state credibility weighted claim rate according to an exemplary embodiment of the present invention;

FIG. 8 is a flowchart illustrating a method of calculating an industry credibility weighted claim rate according to an exemplary embodiment of the present invention;

FIG. 9 is a flowchart illustrating a method of determining state continuation load according to an exemplary embodiment of the present invention;

FIG. 10 is a flowchart illustrating a method of calculating a weekly benefit amount for a state according to an exemplary embodiment of the present invention;

FIG. 11 is a flowchart illustrating a method of calculating a government unemployment insurance contribution according to an exemplary embodiment of the present invention;

FIG. 12 is a flowchart illustrating a method of calculating a claim cost according to an exemplary embodiment of the present invention;

FIG. 13 is a flowchart illustrating a method of calculating a premium payment with no waiver according to an exemplary embodiment of the present invention;

FIG. 14 is a flowchart illustrating a method of calculating a premium payment with waiver according to an exemplary embodiment of the present invention;

FIG. 15 is a chart showing weekly percentage unemployed for Washington, D.C.; and

FIG. 16 is a table showing an annuity factor for each week of the coverage period for a group private unemployment insurance policy according to an exemplary embodiment of the present invention.

### DETAILED DESCRIPTION

Unemployment insurance is a benefit currently funded in the United States of America by contributions made by employers (to state and federal governments) on behalf of employees, to protect employees against pure income losses in the event an employee loses his or her job. It is overseen by the federal government but administered by the states. Should a worker be fired or laid off, he or she may receive unemployment benefits in the form of a weekly “replacement” of a portion of his or her salary, for a period of time, provided the job loss was of no fault of the worker. Currently, the federal/state unemployment insurance (UI) program will provide benefits to eligible workers (i.e., those who involuntarily lose their jobs and who are actively looking for work) with supplemental income for a period of up to 26 weeks. This coverage can be extended by the federal government if the unemployment rate in the state is high; in this situation, the federal and state governments share the cost of providing the extended benefits.

Typically, three main criteria have to be satisfied before a worker is eligible for government-sponsored unemployment benefits: the person must have lost his or her job through no fault of his/her own; the person must be ready, willing, and able to take on “suitable” new work; and the person must have earned a certain minimum amount of money in the past year. Usually the first four of the last five completed calendar quarters at the time of application is considered the “past year.” Not everyone who loses a job meets these conditions. For example, some people quit their jobs or are disqualified because of misconduct, or their income is too uneven. Therefore, the number of people who qualify for unemployment benefits is substantially smaller than the number of people who are unemployed.

The federal government establishes minimum standards for UI systems, though each state has its own laws and administrative system. The state government typically has to ascertain three things about an unemployed worker seeking benefits, to validate his or her claim. First, whether the worker qualifies for benefits, as discussed in the previous paragraph. Next, the number of weeks of benefits available. This can be shorter than the standard 26 weeks for various reasons, such as the worker's earnings pattern was uneven or her work history was shorter than required for full benefits. Finally, the dollar amount of weekly or monthly benefits must be calculated. For policy reasons, the maximum income supplement usually is a specified fraction of the claimant's pre-unemployment income (hereafter called “original income”), but there also may be an upper limit to supplements; for example, New York State provides a maximum weekly benefit of $405 in 2008. Therefore, for a lower-paid worker, the benefits will reach about 50% of the worker's original income, but for a worker who originally earned a higher salary, the benefits might only reach 25% of his or her original income or some other percentage—perhaps even lower. At current rates, national data indicates UI covers, on average, about 38% of an employee's original income.

### Problems with the Current Insurance Model

To many recipients of benefits, the low coverage percentage and dollar ceilings are serious deficiencies of the current government-mandated unemployment insurance model. Historically, however, unemployment benefits were not meant to substitute for work-based income but instead to “soften the fall” of unemployment, by “replacing” (i.e., supplying) approximately 50% of the worker's original income. That number was thought to be a percentage that would allow the worker to maintain a minimal standard of living and/or to avoid defaulting on his financial obligations, while leaving sufficient incentive for the worker to aggressively search for new employment. As a result of the cap on maximum weekly benefit payments, higher-paid workers (e.g., those at the eightieth or ninetieth percentile) are usually not compensated at anywhere close to the 50% rate. Above a certain original income level, the maximum government compensation limits UI to less than 50% of original income earned by top-paid employees. Moreover, wage inflation in the absence of comparable adjustment of the maximum weekly benefit typically causes, over time, an increasing portion of the claimant pool to be receiving replacement income below the 50% target—i.e., income inadequate to meet their minimal needs for living and avoidance of default on obligations. Yet government-provided unemployment compensation has been observed to fail to keep up with increases in above-median wages, leaving increasing portions of the population at risk of finding UI payments quite inadequate to meet their needs. Further, if the state or federal government proposes to increase employer or employee contributions to unemployment insurance, resistance is often encountered.

While unemployment may happen on an individual basis, it is also true that unemployment may occur to multiple workers of a common employer at a single event, generally called a layoff. A layoff may have the effect of making it more difficult for the individual worker to obtain a new job because of the resulting local increase in unemployment, especially if some of the other laid off workers share job qualifications with the individual UI claimant.

A need thus exists for a private unemployment insurance system and coverage, addressing one or more of the deficiencies of government-administered UI. There is particularly a need for private unemployment insurance that addresses the contingency of a layoff occurring.

Attempts have been made in the past to provide private unemployment insurance, both as a replacement for and as a supplement to government UI. For example, see U.S. patent application Ser. No. 10/729,444 of Suresh Annappindi, titled “Unemployment Risk Score and Private Insurance for Employees.”

However, past attempts have suffered from one or more deficiencies including, but not limited to, use of pricing methods that fail to account for relevant factors including actual claims experience data, cost structures and claims processing criteria and methods that introduce unwarranted expense and delay, and lack of attention to claim severity due to layoffs.

### Definitions of Insurance Terms

Unless otherwise appears expressly or from context, the following terms have indicated meanings:

Underwriting—The process in which a large financial provider assesses the eligibility of customers to receive its products.

Incidence—A measure of the unemployment rate. The number of government approved UI claims divided by the total number of U.S. non-farm payrolls.

Moral hazard—The possibility that a party insured from risk will behave differently than it would behave if fully exposed to the risk (i.e., uninsured).

Adverse selection—Due to information asymmetry, people who subscribe to an insurance policy are those who perceive themselves likely to experience the insured contingency.

Continuance table—A table used for insurance premium calculations based on the probability a claim will continue, by time and amount.

Insurance—Coverage by contract whereby one party undertakes to indemnify or guarantee another against loss by a specified contingency or peril.

Loss Ratio—Ratio of losses paid or accrued by an insurer to premiums earned.

### Insuring Individual Job Loss Vs. Layoff

Insurance methods which do not treat individual loss of employment and layoff events as distinct circumstances cause premium calculations to be excessive relative to the risk of individual loss of employment or fail to protect the insurer against the magnitude (i.e., severity) of claims that may result from layoffs. Accordingly it is desirable to price separately coverage for individual job loss risk and layoff risk. Benefits, as well, may be treated separately as an individual may wish to purchase more benefit (either higher payments or payments of longer duration) in the event of a layoff or in the event of his/her singular job loss in a non-layoff situation.

The main reason unemployment insurance is underwritten by the government, and not private industry, is that unemployment insurance, as defined, has not been attractive to a for-profit private insurer. It does not offer to a private insurer many of the characteristics important to a typical insurer when it is deciding whether to underwrite a risk. Generally, the insurance industry desires the following characteristics to be present before it will create an insurance product (policy):

The probability of the insured risk should be reliably predictable for large numbers of insureds, though for one insured the probability of an insured event need not be reliably predictable.

The occurrence of an insured contingency (event) is beyond the insured's control.

The insured contingency, if it occurs, causes a precisely defined or ascertainable monetary loss.

The contingency can be defined precisely and its occurrence, or lack thereof, can be clearly and easily determined.

After the contingency occurs, the amount of monetary loss should be the insured's control.

The incidence of occurrence of the contingency is sufficiently low as to justify the charging of premiums attractive to the potential insureds. Put another way, an insurer should be able to calculate with some accuracy both the estimated frequency of claims and their severity, so as to be able to achieve a predictable profit over a sufficiently long interval. Premiums should be affordable. Losses (in this case, the payout on unemployment claims) should be non-catastrophic to the insurer. An insurer should be sufficiently well capitalized that an early heavy claims experience not put the insurer out of business before its long-term profitability can be established. To provide statistics that will justify an insurer risking its capital, claims should be well defined and bounded. That is, those statistics should be such that the potential for many homogeneous exposures to claims is manageable. The insured's loss must be accidental and measurable. From the perspective of an individual insured, one might not be able to measure easily and accurately the loss he or she incurs due to unemployment, but for the insurer, the loss can be made measurable by offering a fixed amount of benefit payable to the individual for a maximum amount of time.

Unemployment may not be entirely outside the employee-policyholder's control, of course. An employee may bring about his or her own termination. Past proponents of private unemployment insurance have thus assumed the need for a claims approval process by which the insurer would take appropriate steps to verify that the claimant's unemployment was not of his or her own creation. This process may require considerable expense and create delay in the claims resolution process. By contrast, as further explained herein, an insurer may take advantage of the fact that the state unemployment administration also must determine that an employee was not at fault in creating the unemployment circumstance. The private insurer can “piggyback” on this determination and avoid duplicative effort if the insurance terms are crafted appropriately to reflect the same criteria as are employed by the state, and to accept the state's determination of eligibility as definitive of eligibility under the private insurance policy. This approach has the advantage that data is available for most states of the rates of approval of unemployment insurance claims, which data can be used to establish a reliable actuarial model from which premiums can be derived and a predictable profit achieved. It has the apparent disadvantage that eligibility criteria differ from state to state and even if two states purport to employ the same criteria, data indicates those criteria may be applied differently. Indeed, over time the criteria of a given state may be applied differently (e.g., a specific criterion may be employed more stringently one year than a few years earlier or later). Hence, it is useful to address and take into account not only the stated criteria for eligibility, but also the statistics indicating how they are applied—e.g., in the form of eligibility approval rates. Heretofore, it appears that such information was not used by providers or proponents of private unemployment insurance, whether supplemental to or place of government-provided UI.

Creating private unemployment insurance requires the addressing of the characteristics listed above. Life insurance, which actually insures against death, is the clearest example of an insurance that meets the foregoing characteristics. When these characteristics are lacking, to write insurance profitably generally requires coercive power. Occasionally, however, even without such power pressing them, insurers are willing to write coverage that meet only some of these characteristics, often imposing conditions and limitations on coverage, or on eligibility. Many types of health insurance fall into this gray area.

Described below is a system and method for establishing and pricing a supplemental unemployment insurance program that will have the characteristics needed for a commercial insurance product that can provide to insureds either directly or through the insureds' employer an additional amount of income benefit on the occurrence of unemployment, over and above the payments received from government UI.

To distinguish the supplemental private unemployment insurance from government UI, we shall refer to it as “PUI,” for short.

With appropriate conditions and payment terms, any eligible cause of termination of employment may be covered, both individual instances of job loss as well as layoffs or reductions in force.

Though an example is not given below, it is contemplated that in some implementations, the insured worker's benefits might differ as between different types of terminations, such as an individual termination or a layoff. A worker might be concerned that mass layoff might make it more difficult to find new employment than an individual loss of position, for example, so that such a worker might wish to purchase different benefits in those two contingencies.

If a layoff is a (or even the only) coverage-triggering or defining event, of course, it will be necessary that the insurance contract define a covered layoff. For example, and without limitation, a layoff might be characterized as there being 50 initial claims for unemployment insurance by an employer's workers within a 5-week period, and that such claimants were separated from their jobs for at least 31 days. (The latter requirement suggests a waiting period, before benefits begin, of perhaps sixty days.) Of course, other characteristics or other numerical values might be adopted.

The underwriting of such insurance is complicated by several challenges. First, there is an inherent information asymmetry between the employees, who know their jobs may be “on thin ice” and the insurers. Thus, the probability of unemployment risk is difficult to calculate globally by an insurer, although individual employees may have a better understanding of their chances. This presents a risk of adverse selection by prospective insureds. Second, and related, unemployment is not necessarily beyond the control of the worker. Fortunately, however, there is already a process in place to decide who is/was at fault for termination. Thus, the insurer can base its approval or disapproval of a claim on the findings of the state agency that administers UI claims. Third, the monetary loss due to unemployment varies for reasons as variable as the workers themselves, and the incidence of unemployment is relatively high; the average worker in the U.S. transitions from one job to another once every five years—not all such situations including an eligible period of unemployment, of course. So good data on potential losses is paramount in the pricing process.

Desirably, the underwriting criteria for a PUI product preferably are designed to meet the goals and address the issues listed above, including to reduce adverse selection and to address the potential “moral hazard,” so-called, of providing a benefit that reduces too much the individual's incentive to seek new employment. For example, the following criteria (or similar), in their entirety or in part may be used for underwriting such insurance successfully:

As a condition for paying a benefit, the insured must qualify for government unemployment benefits, both when the claim is initially requested as well as throughout the duration of the interval in which the claimant collects unemployment benefits payments. (This provides an easy way to verify that a period of involuntary unemployment has commenced and is continuing. A practical implementation is discussed below.)

Impose a waiting period after a policyholder loses his job, before benefits begin. The waiting period might be two weeks, for example. This is done to encourage an insured to begin a job search immediately and thus reduce the moral hazard risk of a laid-off insured not earnestly looking for new employment right away.

Disqualify from eligibility unemployment commencing within a specified interval from the purchase of the coverage (insurance policy or certificate of participation in a group policy). The use of such a waiting or elimination period is intended to discourage a company or its workers from buying PUI based on knowledge that a layoff event is about to transpire. This concern by an insurer is accentuated when the insured contingency is a mass layoff and benefits might have to be paid for dozens or even hundreds of workers. So in the case of layoff coverage, a long elimination period might be imposed, such as 145 or 180 days from purchase, for example, and a shorter period for a non-mass layoff coverage.

The employee might be required to be earning a minimum salary, such as $65,000 per year, to qualify for coverage. The salary should be high enough that government unemployment compensation is less, or substantially less than 50% of that salary.

The employee may be required to work for an employer who meets specified criteria (e.g., as to number of employees, layoff history, history of unemployment claims, etc.).

The unemployment benefit will be based on the salary that the employee had earned during a defined period prior to the loss of employment. The benefit will be a portion of the insured's previous salary, such as 50% minus that which he receives from state unemployment.

The unemployment benefit will not extend beyond either the insured finding new employment or a stated maximum duration following the commencement of payments under the policy, such as a maximum of six months after the termination of employment. This period may be coextensive with state UI benefit payments, or it may be a longer or shorter interval.

As stated above, in some embodiments an individual worker may contract for such insurance directly with an insurer. In some embodiments, an individual worker may purchase such insurance via his/her employer on an individual basis. In some embodiments, a worker may purchase such insurance as a participant in a group insurance plan sponsored by the employer. The insurer may, but need not, impose a possible minimum participation requirement within the company, so that there is sufficient diversification. This purchase of coverage may also be partially subsidized by an employer. Alternatively, in some embodiments, the employer may purchase and pay for the PUI, with the benefit paid to a covered employee, in lieu of, or to supplement, a severance package. This can be restricted to certain classes of employees (management, or salary thresholds) or made available to all employees to ensure the employer does not choose employees that are being selected for a layoff Hybrid arrangements are also possible, with employer and employee sharing costs.

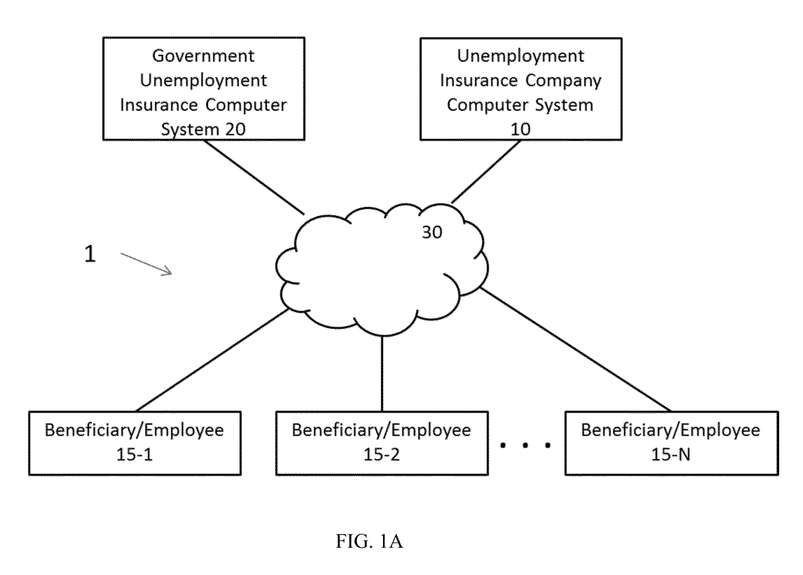

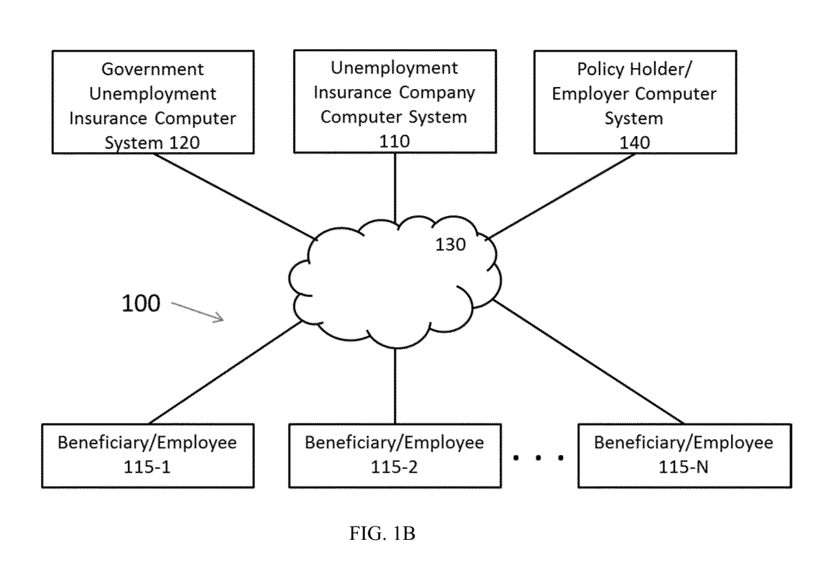

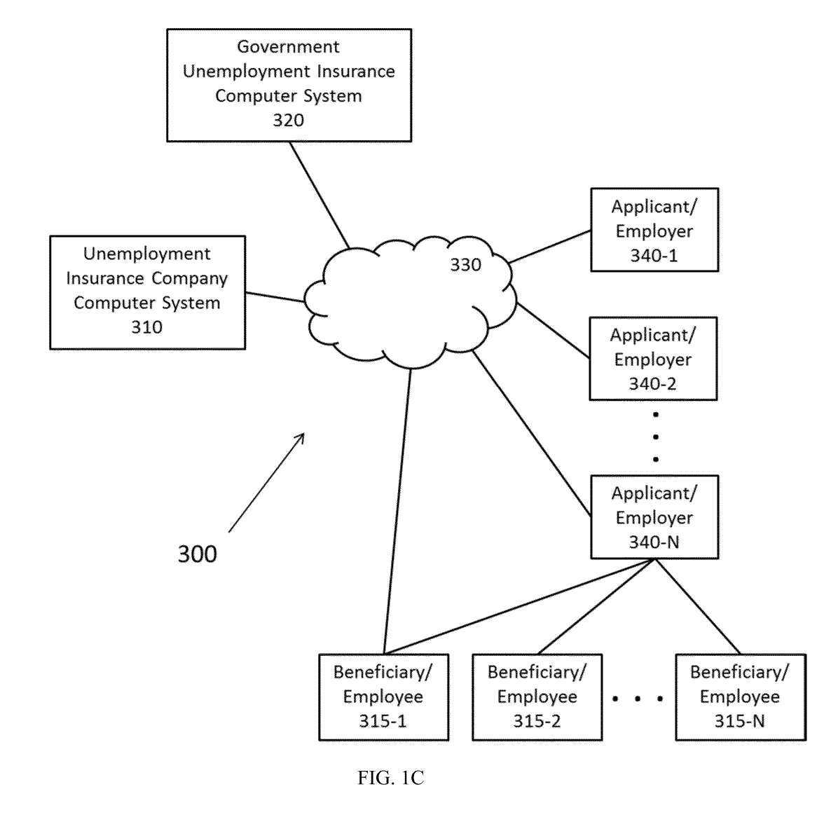

FIG. 1A is a block diagram illustrating a system, generally designated by reference number 1, for providing private unemployment insurance according to an exemplary embodiment of the present invention. The system 1 includes a private unemployment insurance (PUI) provider computer system 10 configured to have the ability to access data from various federal and state computer systems 20 and use such data to underwrite and provide private unemployment insurance to individuals 15-1-15-N. In this regard, the PUI provider computer system 10 includes one or more databases, one or more processors, and one or more computer readable media that store instructions that are read by the one or more processors to perform the various steps of the present invention, including processing insurance applications, calculating premiums, processing insurance claims, and providing payouts to insured individuals. Data from the federal and state computer systems 20 may be accessed over a network 30, such as a private network or a public network, such as the Internet, and stored in the one or more databases of the PUI provider computer system 20. The PUI provider computer system 20 may provide individuals with a graphical user interface on individual user devices, such as mobile phones or personal computers, that allows for submission of electronic forms, such as, for example, insurance application forms and claim forms, as well as checking status of insurance and claim processing.

FIG. 1B is a block diagram illustrating a system, generally designated by reference number 100, for providing private unemployment insurance according to another exemplary embodiment of the present invention. The system 100 differs from the previous embodiment in that the private unemployment insurance is provided to individuals, who are employees of an employer, through the employer as part of a group private unemployment insurance plan. The system 100 includes a private unemployment insurance (PUI) provider computer system 110 configured to have the ability to access data from various federal and state computer systems 120 as well as an employer computer system 140 and use such data to underwrite and provide a group private unemployment insurance plan to an employer so that the employer may provide private unemployment insurance to its employees 115-1-115-N. In this regard, the PUI provider computer system 110 includes one or more databases, one or more processors, and one or more computer readable media that store instructions that are read by the one or more processors to perform the various steps of the present invention, including processing insurance applications, calculating premiums, processing insurance claims, and providing payouts to insured individuals. Data from the federal and state computer systems 120 may be accessed over a network 130, such as a private network or a public network, such as the Internet, and stored in the one or more databases of the PUI provider computer system 110. The PUI provider computer system 110 may provide individuals with a graphical user interface on individual user devices, such as mobile phones or personal computers, that allows for submission of electronic forms, such as, for example, insurance application forms and claim forms, as well as checking status of insurance and claim processing.

FIG. 1C is a block diagram illustrating a system, generally designated by reference number 300, for providing private unemployment insurance according to another exemplary embodiment of the present invention. The system 300 differs from the embodiment shown in FIG. 1B in that the system 300 includes a plurality of employer computer systems 340-1-340-N, each of which may be associated with one or more of a plurality of employees 315-1-315-N. The system 300 includes a private unemployment insurance (PUI) provider computer system 310 configured to have the ability to access data from various federal and state computer systems 320 and use such data to underwrite and provide a group private unemployment insurance plan to an employer so that the employer may provide private unemployment insurance to its employees 315-1-315-N. In this regard, the PUI provider computer system 310 includes one or more databases, one or more processors, and one or more computer readable media that store instructions that are read by the one or more processors to perform the various steps of the present invention, including processing insurance applications, calculating premiums, processing insurance claims, and providing payouts to insured individuals. Data from the federal and state computer systems 320 may be accessed over a network 330, such as a private network or a public network, such as the Internet, and stored in the one or more databases of the PUI provider computer system 310. The PUI provider computer system 310 may provide individuals with a graphical user interface on individual user devices, such as mobile phones or personal computers, that allows for submission of electronic forms, such as, for example, insurance application forms and claim forms, as well as checking status of insurance and claim processing.

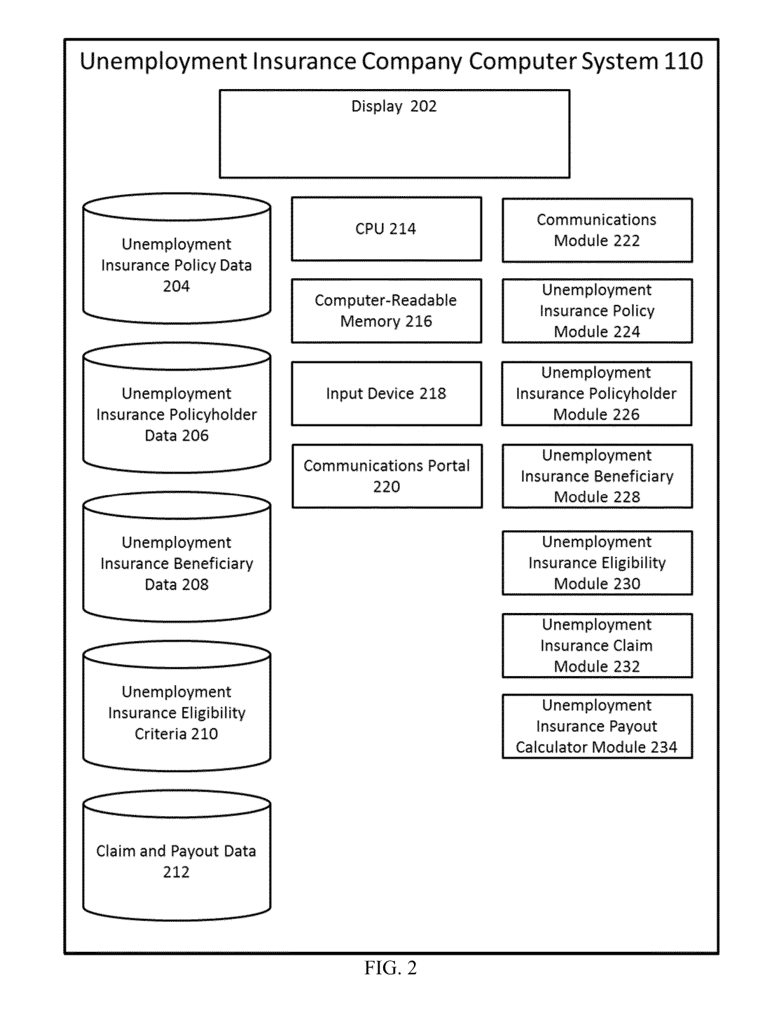

FIG. 2 is a block diagram illustrating a PUI provider computer system 110 according to an exemplary embodiment of the present invention. The PUI provider computer system 110 may include a display 202, which may display, but is not limited to displaying, data associated with PUI, an input device 218 for receiving input or data from a user and/or a communication portal 220, which may be used to transmit and/or receive data (e.g., to other users and/or other devices). The PUI provider computer system 110 may also include non-transitory computer-readable media, such as computer-readable memory 216, that contains instructions that are read by one or more processors, such as CPU 214, to perform the various operations in providing and servicing a group PUI policy, such as, for example, processing applications for group PUI, determining eligibility for group PUI, calculating amount of premiums to be charged to the employees under each group policy, generating a group PUI master policy to be provided to the employer, processing claims, and calculating and providing payouts, to name a few. In this regard, the PUI provider computer system 110 may include various modules, which may be embodied in separate hardware elements and/or separate algorithms performed by the CPU 214, either alone or in combination with one or more other processors, including, for example, a communications module 222, an unemployment insurance policy module 224, an unemployment insurance policyholder module 226, an unemployment insurance beneficiary module 228, an unemployment insurance eligibility module 230, an unemployment insurance claim module 232 and an unemployment insurance payout module 234. Each of these modules is described in detail below.

The unemployment insurance eligibility module 230 may process applications received from employers for a group PUI policy and determine eligibility for group PUI. In this regard, an employer on-line application may be electronically generated at the employer's computer system 140 or at the PUI provider computer system 110 using data input at the employer's computer system 140 and received via the communications module 222 of the PUI provider computer system 110. The unemployment insurance eligibility module 230 may present to an applicant a series of screens (i.e., pages) containing information requests, receive responses from the applicant, and verify certain information. Information that the insurer desires to verify before issuing a policy often can be checked by electronically accessing databases (public and private) that contain suitable data, such as, for example, address directories and telephone directories, business records of the state government, etc.

Over time, in addition to using data available from state and federal government records and reports, data may be collected as a result of an insurer developing a history of experience with such PUI policies. Or additional sources may be found. All of such data may be used to refine the calculation of premiums by adding risk factors into the calculations or refining the values used for risk factors, or replacing risk factor numbers with functions from which values may be computed. Such data may include some or all of the following, for example:

Employment history: Employees with stable work histories are least likely to get laid off in the future. Thus, employers in an industry in which employees generally have a volatile employment history may be charged a higher premium than employers in industries where employment history is more stable.

Current Salary: Certain salary ranges may be excluded or subject to additional adjustments. For example, employees making less than $65,000 per year may exhibit higher moral hazard risk in the event of a layoff. Correlating salary with claims experience over time may allow an insurer to develop salary-based premium adjustments.

Status of employer: Some employers might be particularly risky or safe institutions. For example, impending bankruptcy proceedings at an employer might result in its employees being temporarily ineligible for signing up for coverage. A database may be maintained of news events for major employers, for example, and a rating assigned to such employers based on relevant information.

Current industry: Different industries exhibit different layoff patterns. An employer in the field of education might face much lower risk of job loss than emplyer working in the financial services industries, all other variables held constant. An industry factor can be invoked to reflect these differences.

Job Function: Certain job functions may exhibit distinct susceptibility to layoff events. For example, secretaries may be less likely to be laid off than investment banking associates, all other variables held constant. In other words, even within the same industry, occupational factors may lead to differences in incidence rates. With reliable data gathering, a job function adjustment may be applied in premium calculation.

In order to collect data about PUI applicants, any suitable form of data collection may be employed. For example, a web form may be provided via an Internet web server to the application in order to collect desired information. The data collection process may be organized into several stages. For example, on a first page, standard basic information may be collected such as: name of company, address, telephone number, e-mail address and federal ID number. Preferably, processes are executed by the system to verify all this information. If any information is inconsistent with existing sources, a flag may be set to start a process to resolve the inconsistency. For example, the name, address and industry may be checked against a database (such as Ward's Business Directory of U.S. Private and Public Companies) to make sure they exist and are in agreement. As many pages may be presented as necessary to gather all of the information the insurer desires, such as, but not limited to, company size, average length of employment of employees, employee's history with respect to collecting unemployment compensation, employee's financial history and other relevant factors. This information may be used to check for adverse selection risks on part of the employer. If the employer-applicant does not meet certain criteria, the employer may be notified that the insurer will not offer a policy.

If the employer-applicant is accepted for a group PUI policy, the unemployment insurance policy module 224 may generate a policy, including calculation of an appropriate premium to be charged to each employee under the policy. In this regard, premiums may be determined in relation to benefits to be provided and the actuarial risk of a claim. Fortunately, a considerable amount of useful data is available in most states. That data can be accessed on an as-needed basis from state government computer systems, or downloaded to a data store operated by an insurer or at least accessible to the insurer.

The basic mathematical structure of most insurance coverage is that claim cost (i.e., payout) is the product of the number of claims expected during the coverage period and the expected average severity of the claims. Premiums can then be set to cover expected claims costs, administrative cost and desired profits. Of course, there is no single number that defines potential claims costs. The actual cost that will be experienced is an unknown. A probability distribution for claims costs may be constructed and a number may be used in the premium determination that represents a high probability that the actual claims will be a lesser value. Thus, an insurer might use a number representing a 90%, 95%, or other confidence level that it exceeds the actual claims that will be received.

For supplemental PUI, the cost structure is somewhat more involved. While the firing of a single employee may be unrelated to the experiences of others, a given layoff event can give rise to a number of claimants. It may thus be desirable to price such insurance in relation to the contingency(ies) insured. Thus, in some embodiments, a premium may comprise a first component related to the expected cost of an individual loss of employment and a second component related to the expected cost of a layoff event, taking into account that it may not be entirely possible to distinguish the two situations. Of course, a PUI policy may cover only a layoff contingency and not an individual job loss, or vice versa. The coverages may be offered separately or bundled together.

For a layoff, the claim cost may be the product of (1) the number of insured events (layoff events) expected during the coverage period at employers where coverage is provided to at least one employee, (2) the average number of claimants per event, (3) the average amount of weekly benefit that will be paid to the claimants, and (4) the average duration (i.e., number of weeks) these claimants will qualify for payments.

Claim cost calculations may vary depending on the exact nature of the policy sold, including contingencies insured, weekly benefit, duration of benefits, etc. The weekly benefit depends upon factors such as the percentage of pre-unemployment income being replaced, amount of underlying state UI, etc.

The more involved the policy structure, the more involved the calculations required in setting premium rates. However, with proper statistical analysis it is not a drawback. One statistically significant phenomenon unique to layoff coverage is that claims are coupled, not independent. If one insured gets laid off, chances are that other insureds will be involved in the same layoff event. Thus, loss data will demonstrate a “lumpy” pattern in projected losses, as opposed to a smooth curve. Thus, it is probable that in some years, few claims will be filed, while in other years, many claims will be filed. This lumpiness is enhanced by the cyclical nature of layoff events (discussed later).

This is in contrast to policies such as disability insurance, where each insured has an independent chance of experiencing an insured contingency and making a claim for benefits. However, barring an unusual major disaster (which may be treated via exclusions and benefit reductions), the number of claimants will usually not vary very much from year to year.

The US Department of Labor maintains a statistical database with extensive public information about the United States labor force. Available data include:
number of insured events (layoffs) per year since 1998
average number of claimants per event since 1998
the above information segmented by industry

The Department of Labor considers a layoff to be an incidence of involuntary unemployment of 50 or more workers at a given firm, where the workers become involuntarily unemployed over a period of less than five weeks. Further qualifications include that the workers must be eligible for unemployment insurance, and remain laid off for at least 31 days. Since 98% of full-time employees are covered by unemployment insurance, the Department of Labor database is a reliable estimator of expected layoff patterns for the future for the United States workforce.

Preferably, one or more insurers who commercialize supplemental PUI as defined herein may collect data that will in the future allow for greater segmentation of the marketplace in setting premiums. For example, eventually rates may be refined to account for the size of the employer, as companies of different sizes or in different regions may exhibit different layoff patterns.

Many factors can be used in calculating premiums for a PUI policy. That is, many factors have predictive value in determining the probability of an individual receiving government unemployment benefits (severity) and the length of time he would be receiving those benefits (duration). These factors can be broken down into four categories: Personal, Corporate, Industry, and Economy.

Personal Indicators include, for example, some or all of age, gender, race, income, occupation, credit score, geography, marriage/family status, homeownership, employment (unemployment) history, and education. The Personal Factors as averaged across all employees of an employer-applicant may be used in calculating a premium to be charged to each employer under the policy offered to the employer-applicant.

Corporate indicators are attributes of the employer-applicant and may include, for example, years in operation, stock price, price to earnings ratio, historical company employment trends, cash flow, revenue and profit changes, and unemployment experience rating, to name a few. According to an exemplary embodiment of the present invention, the experience rating may be used as part of an underwriting process that the PUI provider may used in determining eligibility for insurance and premium amount and rates. For example, employers that have a history of a large number of lay-offs and terminations may be charged a higher premium than other employers with less turnover and/or employers in an industry that in general has a larger number of lay-offs and terminations may be charged a higher premium. Adjustments to the premiums may be made by matching the experience rating with the current economic conditions.

Industry Data include, for example, unemployment and hiring trends in different industries (e.g., as categorized by the North American Industry Classification System (NAICS)), collected at the State and Federal levels, in major and minor divisions; and indexes that indicate the financial performance of different industrial sectors (e.g., Dow Jones Industry Indexes).

General Macroeconomic Data are attributes of the country's market economy and include, for example, GDP growth rates, unemployment rates, unemployment duration, imports/exports, national debt, and leading and coincident indicators (from the Conference Board).

In some embodiments, data from the state unemployment office may be considered, which would indicate how strict or permissive that state is in accepting claims, both in terms of statutory and regulatory requirements determining the definition of an involuntary layoff in that state, and also in terms of the administrative strictness used in applying the statutory and regulatory standard.

It is not to be expected that buyers of PUI will be a random sampling of the workforce. By virtue of the fact that the employee is buying the coverage for himself, or that her employer is making it available or contributing to its cost, it is likely that his/her actual layoff probability is somewhat different than that of the population at large.

By buying non-mandated insurance coverage, the purchaser is demonstrating a strong sense of risk aversion. This may portend a more stable than average job experience, since such an individual may have optimized his job search towards stability and/or may have planned for his loss of income by lining up another job in advance.

Mitigating against these particular factors are adverse selection probabilities. For example, there is a likelihood that the buyer is acquiring coverage due to knowledge he has of a particular impending layoff or of a financial weakness of his employer that might lead to a layoff. Reducing the probability of adverse selection may be achieved in various ways—including having him warrant in his application that he has no knowledge of any impending layoffs that may affect him, and that he has no reason to believe that his company may be declaring bankruptcy. It is also possible to reduce the probability of the buyer taking advantage of an information asymmetry by instituting a waiting period before coverage is available for covered events after premiums start being paid. The longer this waiting period, the smaller the likelihood of an applicant having any relevant foreknowledge that an insured does not share.

In combining appropriately these variables to come up with a forecast of expected net relative severity and duration of claims, two constraints confront the insurer:
(1) lack of publicly reported available data (e.g., detailed population statistics on how unemployment varies with homeownership); and
(2) near multicollinearity of many variables. (i.e., many of the variables listed above correlate very highly with each other, and are nearly redundant when used together.)

When a model has too many parameters for the information content sought from the data, which in this case is the severity and duration of unemployment claims, it is considered “overfitted.” When the degrees of freedom in parameter selection exceed the information content of the data, this leads to arbitrariness in the final (fitted) model parameters, which reduces or destroys the ability of the model to generalize beyond the fitting data. Thus the best underwriting models are those in which the variables correlate minimally with each other, and maximally with the information sought. When trying to run a regression analysis on an overfitted model, different samples from the same population might give highly varying results—i.e., the model is not statistically robust. However, if enough samples are taken, this tendency will be reduced. Due to the lack of publicly reported available data, though, it is better to start with a few highly independent and dispositive variables, for the most parsimonious correct model (following the Bayesian Information and Minimum Description Length Criterion) and then bring in the rest of the data slowly in a machine learning modeling process when the sampling becomes more robust—i.e., when there is more claims data. Hence, a method will be shown for deriving a premium initially using but a few of the most integral variables, and the model will then be refined using the remaining relevant variables.

To create even a simplified premium model (which can then be eventually bootstrapped up by the introduction of more variables) requires high quality statistics that are used together, ideally those that are measured in an identical fashion, at the same point in time to the extent that is practicable. Data from the relevant state unemployment claims office or from household and business surveys meets this objective. (For example, the federal Bureau of Labor Statistics conducts a Household Survey and an Establishment Survey, respectively, the data from which are readily available.) (Thus, note that premiums should be determined state by state, or even more locally that that if the data supports doing so and localized practices are statistically significant deviations from a state-wide whole. Some Federal data is aggregated and will likely lose important statistical information.)

As a start, two data series will be used that are the most reliable and the least correlated: (1) the industry of the employee's company, and (2) the unemployment and claims approval rate of the state of employment.

In the example under discussion, income level is used to calculate the expected amount of a claim, but not for its influence, if any, on the likelihood of an unemployment event. The two main quantities needed to compute from empirical data is the incidence rate which measure the rate at which workers become unemployed per unit time and the persistency rate which measures the rate at which unemployed workers return to employment per unit time. Additionally, the incidence rate should only include people who qualify for unemployment benefits. For the nation the incidence rate is about 6% per year while the rate at which the unemployed are re-hired is about 4% per week.

The system 100 is intended to ameliorate in part the limitations of the state unemployment insurance model discussed above, extending to a broader market a level of income replacement approaching a nominal 50% (or other desired goal). Government unemployment insurance combined with the supplementation thus provided will replace a certain portion of income (e.g., 50%) in order to make the benefit more meaningful to a broader audience. Variations in coverage could allow for larger or smaller percentages of income to be covered, but the nominal figure of 50% will be used to explain the process here (and not in a limiting sense).

Preferably, the insurer will pay a benefit sufficient to achieve a replacement income level equal the lesser of either: (a) 50% of the equivalent weekly wages reported by the insured at the time of application for insurance coverage, or (b) 50% of the insured's equivalent weekly wages as reported by the State Unemployment Compensation Agency to the insured. The actual payments by the insurer will take into account the sum of benefits received from state unemployment compensation and benefits from any additional unemployment insurance policies. Thus, the insurer will pay only up to the total of government and private payments equaling amount (a) or (b), whichever is less.

These conditions are designed to ensure that the applicant applies for an appropriate amount of coverage, and does not over-insure him/herself, and that irrespective of the potential maximum payments there is an incentive for the policy holder to actively seek new employment.

While an insurer is free to impose additional qualifications, in some embodiments it suffices to simplify the insurer's claim verification process for a policy that has benefits that run concurrently with the state's, by accepting proof of payment of state unemployment benefits to qualify a claim to PUI benefits. The benefit may be payable only after an elimination period of some specified number of consecutive weeks of state unemployment benefits. Typically, increasing the elimination period makes the premium smaller. The benefit may end after regular state benefits run out and the insured is no longer receiving state benefits, or a longer benefit period may be provided. Preferably, claims for unemployment occurring fewer than six months after the initial effective date of the policy will be limited to a refund of premiums paid, in order to reduce the risk to the insurer of the applicant having foreknowledge of an impending layoff. These periods can be changed, with corresponding premium changes to reflect the different adverse selection probability.

In this section, a sample method for calculating premium rates is provided though not all aspects or embodiments need employ the example method. For each step, a detailed explanation is given of the quantities involved and how they may be extracted from available data. For purposes of this example, example rates for New York State for the year 2008 will be addressed.

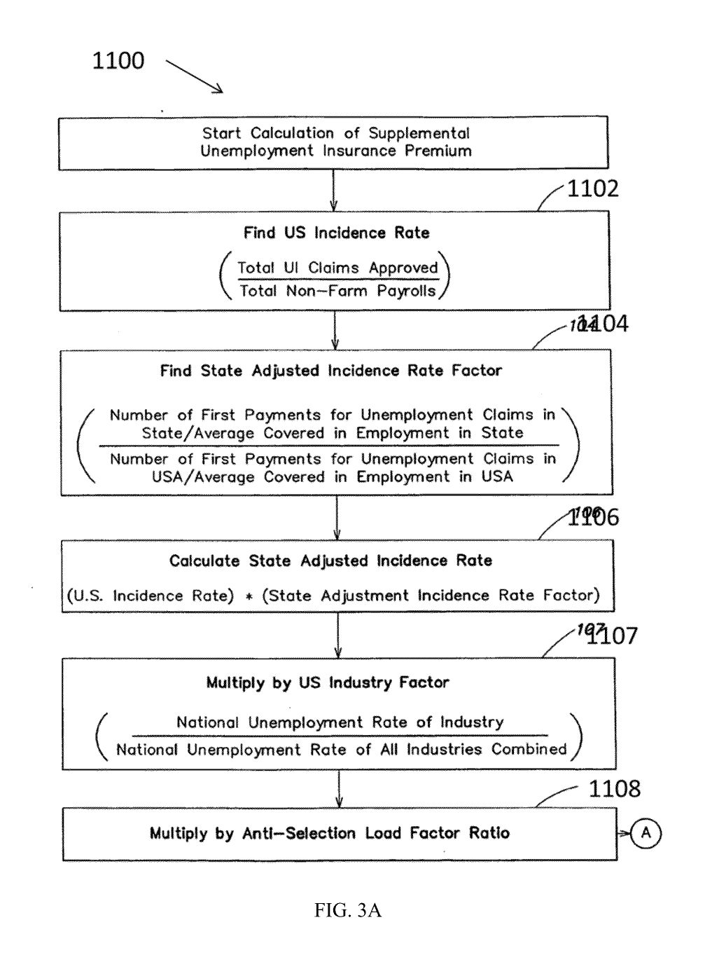

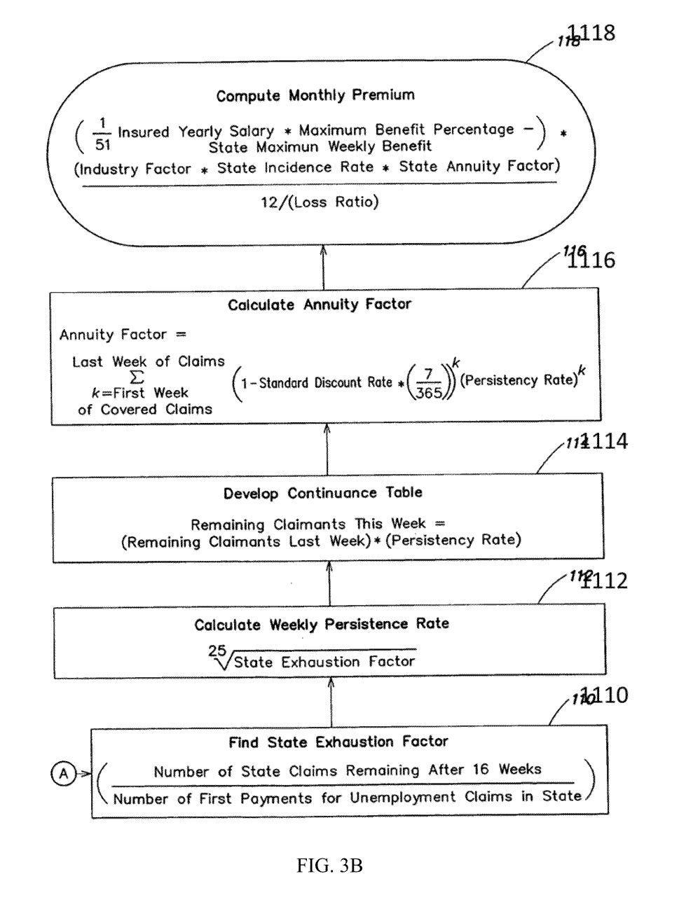

Referring now to FIGS. 3A and 3B, premium computation method 1100 begins in step 1102 with calculation of the Total US incidence rate of UI claims. The total U.S. incidence rate is defined as the number of government approved UI claims divided by the total number of U.S. non-farm payrolls, obtained from Department of Labor statistics (e.g., for the eighteen-year span from 1990 through 2007). The total number of approved unemployment claims as measured by the Number of First Payments over that period was 149,640,126. The non-farm payroll total over the period was 2,229,228,000. Thus, the annual approved claim rate, i.e., what we are calling the total U.S. incidence rate of UI claims, was 6.7%.

In step 1104, starting with the average U.S. Total incidence rate of 6.7%, an adjustment is made to account for state-specific factors and generate a State-Adjusted Incidence rate. The incidence rate adjustment factor for New York in this example is 87.04%. This is found as follows: First, obtain the Number of First Payments (NFP) on unemployment claims in New York in 2007. In this example, NFP=417,686. The average covered employment that year was 8,287,747, for an approved claim rate of 417,686/8,287,747=5.04%. The 2007 Total U.S. number of approved claims was 7,641,942 on an employment base of 131,911,038, for a ratio of 5.79%. The State (i.e., New York) incidence rate adjustment factor is the quotient of these two rates, or 5.04%/5.79%=87.04%. This quotient takes into account the state's unemployment rate and the strictness of its unemployment benefits approval process.

The State-adjusted incidence rate is calculated in step 1106 as the U.S. incidence rate times the state adjustment factor. In the example, it is 0.067 times 0.8704, which equals 0.05831.

In step 1107, the state-specific incidence rate is adjusted (i.e., multiplied by a factor) to reflect experience in the industry in which the insured works. Some industry factors are shown in Table I, below.

TABLE I

| | |
|---|---|
| All Industries | 100.0% |
| Agriculture, forestry, hunting | 106.7% |
| Mining | 76.2% |
| Construction | 137.4% |
| Manufacturing | 101.9% |
| Durable goods | 93.3% |
| Nondurable goods | 117.3% |
| Wholesale and retail trade | 116.4% |
| Transportation and utilities | 81.3% |
| Information | 87.2% |
| Financial activities | 61.4% |
| Professional and bus services | 121.6% |
| Education and health services | 63.9% |
| Leisure and hospitality | 175.6% |
| Other services | 98.6% |
| Public administration | 36.8% |

(Source: U.S. Statistical Abstract, 2007; Unemployment rates by industry divided by All Industries Combined.)

Optionally, in step 1108, an anti-selection load factor is applied to the state and industry-adjusted incidence rate. This allows for the fact that people who purchase the coverage may tend to have a higher frequency of claims than those who decline the coverage as they might have foreknowledge of potential unemployment. However, it is anticipated that the underwriting that is performed at the time of application, as well as the waiting period for benefit eligibility, will offset any substantial anti-selection activity. Therefore, for this example, no anti-selection load factor was used in deriving the New York premium rates.

Other useful factors include the average number of weeks an eligible claimant receives benefits. This can be estimated from the fact that the average duration of unemployment claims in 2006 (the most recent year for which complete data is available as of this filing) was 15.2 weeks. Along with the rate of claim approval and the number of people unemployed each year, this information can be used to estimate the total number of weeks of unemployment collected by all workers in a given year.

Of course, the dynamics are also important. Not all of those claimants would draw benefits at the same time, and averages do not reveal the cash flow demands created by unemployment claims. For use in developing the dynamic picture, in step 1110, an “exhaustion rate” is determined. The exhaustion rate is the percentage or fraction of benefit claimants who receive benefits for the full duration of the benefit period. In the absence of more precise data, one may assume a constant percentage of claimants terminate their benefits each week—either because they are re-employed or because benefits have been exhausted. The percentage of claimants terminating each week is a multiplier that will produce the percentage of claimants who reach the end of their benefit period while still receiving benefits. Using this datum, a geometric distribution (or other appropriate distribution) is constructed, defining as a function of time the number of people who have been unemployed for k weeks.

A weekly persistence rate is calculated in step 1112, as follows: In New York, the 17-year average of the percentage of claimants reaching the end of the 26-week benefits period is 0.469. This rate is fairly consistent in recent years. The weekly claim persistency rate would naturally accumulate to the survivorship of benefits at the end of the 25th week. The 25th root of 0.469 is 0.9702. Therefore, the New York weekly persistency rate is 97.02%. That is, the weekly persistency rate indicates the rate at which claimants one week proceed to being claimants the next week.

Optionally, it may be desirable to adjust the weekly persistence numbers to take into account so-called “moral hazard” concerns. A moral hazard adjustment reflects that people may tend to change their behavior after they have purchased the lay-off insurance coverage and anticipate payment of benefits. In other words, PUI may somewhat reduce the incentive for UI benefit recipients to find new work. For example, if the moral hazard adjustment is two weeks, for the first two weeks after the claim is incurred a persistency rate of 100% may be assumed.

Using the persistency rate calculations, a continuance table may be generated. Step 1114. The continuance table is a schedule of the fraction of claimants that will remain receiving benefits, week by week, given that a claim was incurred in the first week. The formula used in developing such a table is: [remaining claimants this week]=[remaining claimants last week]*[persistency rate].

The continuance table is then discounted in Step 1116. The continuance table may be discounted using an interest rate to obtain annuity factors corresponding to a claim that has been outstanding for any particular number of weeks. A 5% (or other applicable) annual interest rate may be used as a discount rate and summed to develop an unemployed annuity factor, Step 118. For the 24-week benefit in New York in this example (after a two-week non-payment interval for moral hazard protection), the unemployed annuity factor is 16.599936. The weekly example calculation is below:

$$[ annuity ] = {\sum }_{k = 3}^{26} {( 1 - 0.05 * ( 7 / 365 ) )}^{k} {( 0.9702 )}^{k}$$

Table II below charts an example continuance table using such a 5% annual discount rate (0.000938713 weekly) and a weekly claim termination rate of 0.97019226, which above was rounded to 0.9702.

TABLE II

| Week of | | Interest | Persistency × |
|---|---|---|---|
| Unemployment | Persistency | Factor | Interest Factor |
| 3 | 0.970192257 | 0.997189141 | 0.967465183 |
| 4 | 0.941273016 | 0.996253944 | 0.937746955 |
| 5 | 0.913215793 | 0.995319625 | 0.908941600 |
| 6 | 0.885994891 | 0.994386182 | 0.881021077 |
| 7 | 0.859585384 | 0.993453615 | 0.853958207 |
| 8 | 0.833963084 | 0.992521922 | 0.827726643 |
| 9 | 0.809104527 | 0.991591103 | 0.802300850 |
| 10 | 0.784986947 | 0.990661157 | 0.777656077 |
| 11 | 0.761588258 | 0.989732082 | 0.753768333 |
| 12 | 0.738887032 | 0.98880388 | 0.730614364 |
| 13 | 0.716862477 | 0.987876547 | 0.708171629 |
| 14 | 0.695494425 | 0.986950085 | 0.686418282 |
| 15 | 0.674763306 | 0.986024491 | 0.665333146 |
| 16 | 0.654650135 | 0.985099765 | 0.644895695 |
| 17 | 0.635136493 | 0.984175907 | 0.625086034 |
| 18 | 0.616204507 | 0.983252915 | 0.605884878 |
| 19 | 0.597836842 | 0.982330789 | 0.587273537 |
| 20 | 0.580016675 | 0.981409527 | 0.569233891 |
| 21 | 0.562727688 | 0.980489129 | 0.551748381 |
| 22 | 0.545954046 | 0.979569595 | 0.534799983 |
| 23 | 0.529680388 | 0.978650923 | 0.518372200 |
| 24 | 0.513891811 | 0.977733112 | 0.502449040 |
| 25 | 0.498573856 | 0.976816163 | 0.487015001 |
| 26 | 0.483712495 | 0.975900073 | 0.472055059 |
| Total | | | 16.59993604 |

For each state in which such PUI is offered, the applicable maximum unemployment weekly benefit should be determined from generally available sources. Using the weekly benefit, it is possible to determine the benefit that will be paid to a claimant, based on the amount of income replacement purchased. The New York maximum weekly benefit at the time this is written, for example, is $405.00. So, the weekly benefit from the insurer is 50% of covered wages, less $405.00.

Using the above information, a premium may be computed, Step 1120.

Gross premiums may be calculated for each individual at the time of application, preferably by a computer program. A sample rate calculation for an applicant is provided below.

Base premium rates may be adjusted periodically to reflect changes in the rate of unemployment incidence.

The unemployment insurance policyholder module 226 provides for generation of relevant data 206 related to the policyholder (e.g., the employer) and communication of such data to the policyholder. For example, the policyholder may request and receive updates on an insurance application, may receive confirmation of insurance (e.g., in the form of a delivery of a master insurance policy), and may receive forms and other electronic information for administration of the PUI to employees. In general, the unemployment insurance policyholder module 226 may provide the electronic gateway between the employer and PUI provider.

The unemployment insurance beneficiary module 228 provides for generation of relevant data 208 related to each employee under the group PUI coverage and communication of such data to the employee. For example, the unemployment insurance beneficiary module 228 may provide a mobile app that allows an employee to access information regarding coverage, such as the amount of coverage and terms of coverage.

The unemployment insurance claim module 228 may provide for generation of relevant data 212 regarding claims and payouts under the group PUI and communication of such data to employees and the employer-policyholder. For example, the unemployment insurance beneficiary module 228 may provide a mobile app (either the same or different from the unemployment insurance beneficiary mobile app described above) that allows an employer to file a claim, check on the status of a claim and/or receive payouts in electronic form (e.g., direct deposit to the employer's bank account). In this regard, according to an exemplary embodiment of the present invention, the unemployment insurance beneficiary module 228 may receive a direct feed from the state's website and set up a sister account to work with states and provide payouts as expeditiously as possible. The eligibility for a payout under the PUI policy may depend at least partially one whether the state determines that the employer is eligible for a payout under the public unemployment insurance program.

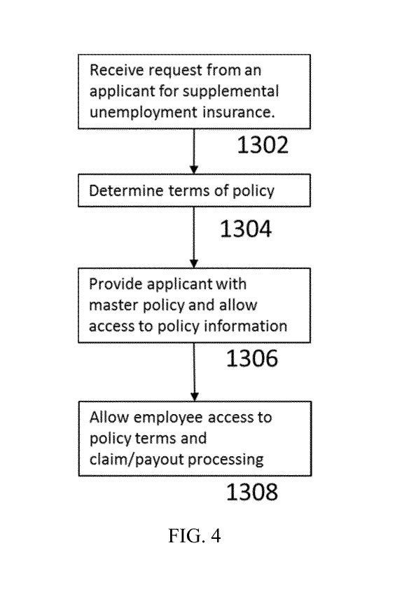

FIG. 4 is a flow chart illustrating a method for providing private unemployment insurance according to an exemplary embodiment of the present invention. In step 1302, the unemployment insurance policy module 224 receives an application from an employer for a PUI group policy for its employees. In this step, data regarding the applicant may be collected directly from the applicant along with data accessed from internal and/or external databases, such as state and/or federal databases, to generate a profile for the applicant and determine eligibility. For example, eligibility criteria may be based at least partially on actuarial risk factors, such as, for example, an experience rating of the applicant that takes into account hiring, firing, termination and lay-offs of the applicant over a predetermined period of time (e.g., during the entire history of the applicant), as well as external factors such as industry and economic environment.

In step 1304, the unemployment insurance policy module 224 may generate a policy, including calculation of an appropriate premium to be charged to each employee under the group PUI policy. Such calculation of premiums may be performed as discussed herein, including performance of an algorithm that takes into account factors such as, for example, years in operation, stock price, price to earnings ratio, historical company employment trends, cash flow, revenue and profit changes, and unemployment experience rating, to name a few.

In step 1306, the unemployment insurance policyholder module 226 provides for generation of relevant data 206 related to the policyholder (e.g., the employer) and communication of such data to the policyholder. For example, the policyholder may request and receive updates on an insurance application, may receive confirmation of insurance (e.g., in the form of a delivery of a master insurance policy), and may receive forms and other electronic information for administration of the PUI to employees.

In step 1308, the unemployment insurance beneficiary module 228 provides for generation of relevant data 208 related to each employee under the group PUI coverage and communication of such data to the employee. For example, the unemployment insurance beneficiary module 228 may provide a mobile app that allows an employee to access information regarding coverage, such as the amount of coverage and terms of coverage.

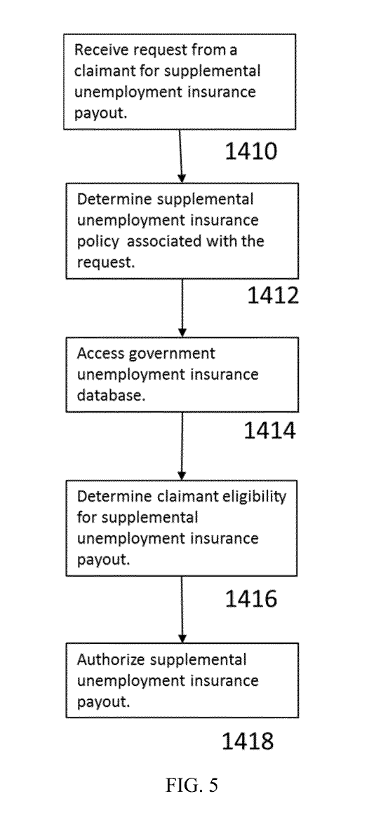

FIG. 5 is a flow chart illustrating a method for processing a private unemployment insurance claim according to an exemplary embodiment of the present invention. In step 1410 of the method, the unemployment insurance claim module 228 may receive a claim for private unemployment insurance via, for example, a mobile app provided by the system 100. In step 1412, the system 100 may determine the policy associated with the claim and the individual employer requesting a payout. In step 1414, the data collected in step 1412 may be used to access state government databases to determine whether the employee has been approved for a payout under the public unemployment insurance policy.

In step 1416, the system 100 determines whether the claimant is eligible for a payout under the group PUI and the terms of the payout. The eligibility for a payout under the PUI policy may depend at least partially on whether the state determines that the employer is eligible for a payout under the public unemployment insurance program.

In step 1418, the system 100 may authorize and/or provide for generation of relevant data 212 regarding claims and payouts under the group PUI and communication of such data to employees and the employer-policyholder. For example, the unemployment insurance beneficiary module 228 may provide a mobile app (either the same or different from the unemployment insurance beneficiary mobile app described above) that allows an employer to file a claim, check on the status of a claim and/or receive payouts in electronic form (e.g., direct deposit to the employer's bank account). In this regard, according to an exemplary embodiment of the present invention, the unemployment insurance beneficiary module 228 may receive a direct feed from the state's website and set up a sister account to work with states and provide payouts as expeditiously as possible. The eligibility for a payout under the PUI policy may depend at least partially on whether the state determines that the employer is eligible for a payout under the public unemployment insurance program.

### Example Calculations

It may be helpful to now consider some realistic examples of situations and to illustrate how premiums may be calculated using the methodology taught herein.

### Generic Calculation of Premium

### Case 1

Consider an applicant who is paid a salary of $80,000 per year, lives in New York and works in the Education and Health Services industry in New York. Under normal state UI rules, clearly this worker would receive the maximum benefit of $405.00 per month.

The Education and Health Services industry sector may be found by reference to available labor statistics to have a substantially lower unemployment rate than the national average. Assume the industry adjustment for this worker is a discount factor of 0.639. The state incidence is 0.5831 and the state annuity factor is 16.60, as computed earlier.

The weekly maximum benefit is half of the worker's normal weekly wages:

$80,000/(52*2)=$769.23

The PUI provides for benefits beyond that which the government provides, up to the coverage limit of

$769.23−$405.00=$364.23 per week

The annual claim cost to the insurer is:

$364.23*0.639*0.05831*16.60=$225.28

This is the cost to the insurer to cover the expected amount of benefits.

The basic monthly premium (adjusting for the loss ratio) is therefore

$225.28/(12*0.49)=$38.31.

This basic monthly premium then should be adjusted to account for a waiver of premium payments when the worker claims unemployment, so the adjusted monthly premium it is $39.30.

### Separating Effects of Demographic Factors

More precision in premium setting can be achieved if it is possible to construct a worker's expected unemployment rate by using components based on demographic factors. In order to more accurately assess the risk of unemployment for an applicant, it would be useful to know his state's and/or industry's contribution to his chances of being unemployed in the future. The basic process presented above simply multiplies “adjustment factors” corresponding to the state, industry, etc. However, one might try to consider more sophisticated approaches.

However, apparently there is no database of unemployment data with a level of detail much different from the Bureau of Labor Statistics reports. There are unemployment rates by type of occupation, industry, gender and state, and other demographic variables. However, greater precision requires unemployment rates which consider all these (and/or other) factors simultaneously. In probability theory it is known that a joint probability distribution cannot be determined uniquely from its marginal distributions. In other words, it is impossible to infer from the data available, any more detailed version of the unemployment rates. Therefore estimates must be based on data which is available from the Bureau of Labor Statistics. A simple geometric approach to that data is proposed here.

Consider three industries: education (Edu), construction (Const) and management (Mgmt), and two states: New York and Texas. Therefore the total combination of industry versus state looks like:

{Edu,Const,Mgmt}×{NY,TX}

Based on prior knowledge of the distributions, a random applicant would be Edu ¼ of the time, Const ⅓ of the time and Mgmt 5/12 of the time. He is also NY 3/7 of the time and TX the rest of the time. The total probability matrix looks like:

| | Edu | Const | Mgmt |
|---|---|---|---|
| NY | A | C | E |
| TX | B | D | F |

Computing the individual probabilities a matrix of four equations in six unknowns results:

$$( \begin{matrix}1 & 1 & 0 & 0 & 0 & 0 \\ 0 & 0 & 1 & 1 & 0 & 0 \\ 1 & 0 & 1 & 0 & 1 & 0 \\ 1 & 1 & 1 & 1 & 1 & 1\end{matrix} ) ( \begin{matrix}A \\ B \\ C \\ D \\ E \\ F\end{matrix} ) = ( \begin{matrix}1 / 4 \\ 1 / 3 \\ 3 / 7 \\ 1\end{matrix} )$$

If this set of equations is row-reduced (e.g., using a computer) the following simpler system results:

$$( \begin{matrix}1 & 0 & 0 & - 1 & 0 & - 1 \\ 0 & 1 & 0 & 1 & 0 & 1 \\ 0 & 0 & 1 & 1 & 0 & 0 \\ 0 & 0 & 0 & 0 & 1 & 1\end{matrix} ) ( \begin{matrix}A \\ B \\ C \\ D \\ E \\ F\end{matrix} ) = ( \begin{matrix}- 9 / 28 \\ 4 / 7 \\ 1 / 3 \\ 5 / 12\end{matrix} )$$

This means there are two degrees of freedom: D and F and the constraints are as follows:

4/7≧D+F≧ 9/28

⅓≧D≧0

5/12≧F≧0

This is a hexagon in the D, F plane whose centroid can be computed. Using a good estimate for (D, F), an estimate can be computed for all 6 probabilities. The resulting value of (D, F) is (0.18, 0.25) and the probability distribution is summarized in Tables III and IV:

TABLE III

| | Edu | Const | Mgmt |
|---|---|---|---|
| NY | 0.112 | 0.148 | 0.168 |
| TX | 0.138 | 0.185 | 0.249 |

TABLE IV

| | Edu | Const | Mgmt |
|---|---|---|---|
| NY | 0.107 | 0.143 | 0.179 |
| TX | 0.143 | 0.190 | 0.238 |

Table III is the distribution if it is assumed the individual variables are not correlated. Some assumptions regarding correlation of the variables is made in generating Table IV. The difference in the two probability calculations between tables III and IV (correlated and uncorrelated), comparing the same probabilities, is on the order of 0.5% which is significant.

While other computational approaches might be used to determine premiums in the absence of detailed data sets, this approach appears to be reasonable based on available data.

### Premium Waiver and Cost

Typically, premiums may be waived during a period of unemployment. The additional cost thus represents to an insurer can be calculated based on a baseline claim cost. The waiver cost may be calculated as the ratio of the baseline gross premium to the benefit cost. The claim cost per $1.00 of weekly benefit (CCWB) is equal to

$$CCWB = \frac{[ incidence rate ] * [ annuity factor ]}{52 * [ target loss ratio ]}$$

In this context, the loss ratio functions like a profit margin. Assume for purposes of illustration a loss ratio of 49%.

In New York, the CCWB thus may be calculated as

$$\frac{0.067 * 0.8704 * [ industry factor ] * [ 16.599936 ] = 0.0380}{52 * .49}$$

Therefore, the monthly premium may be divided by a factor of

1/(1−(3.80%[industry factor]))

to reflect the cost of waiving premiums in addition to payment of claims.

Since premiums are payable on a monthly basis, no active life or unearned premium reserves need be held.

Since the claim cost was calculated on a present value basis using the 5% interest assumption, and there are no active life reserves, no additional consideration need be given to investment income in the premium rate derivation.

### Layoffs

One statistically significant phenomenon unique to this insurance policy is that the claims experiences of insureds may not be independent of one another. If one insured is laid off, there may be other insureds working for the same employer who will be involved in the same layoff event. As stated above, it is advisable to determine a premium for layoff coverage different from that for individual job loss. A model used for layoff PUI premiums should, if possible, take into account factors for the employer's history, the size of the employer's workforce, the relevant industry, etc.

### Extrapolation to a Non-Pure Supplemental Policy

At a simplest level, pricing a premium for more than the typical 26 weeks of state unemployment coverage would simply consist of varying the value of k, the benefit period, to be larger than 26. However, one also may adjust the persistency function, such as to make a discontinuity at the 26 week mark, by comparing the number of claimants reaching the end of week 26, to the number reaching an extended interval of, say, the end of week 39. However, periods when Extended (i.e., 39-week) Benefits are in Effect are also periods when the unemployment rate is unusually high, which is correlated with a longer duration of unemployment. That effect can be mitigated by comparing the 26 week unemployment rate during Extended Benefits Periods. Thus, an adjustment can be made by multiplying the 39 week Extended Benefit persistency rates by the ratio of 26-week persistency rates for regular and extended benefits periods. For example, that ratio might be

$$\frac{{Pers}_{26 Reg}}{{Pers}_{26 Ext}} = \frac{.9702}{.9803} = 98.97 \% , to use typical numbers .$$

### A More Sophisticated Model for Finding a Unemployment Persistency Function

By looking at the number of first claims and first benefits each week, the number of people receiving benefits each week, the number of people exhausting benefits each week, and the size of the workforce each week (all easily available data), it is possible to model the “flow” of employment on a weekly basis. Such a model gives a more accurate week-to-week picture of the rate at which claimants stop collecting benefits each week. This model also informs the differential equations governing unemployment by supplying valid constants, and provides a more powerful framework for calculating how the duration of benefits is affected by different variables.

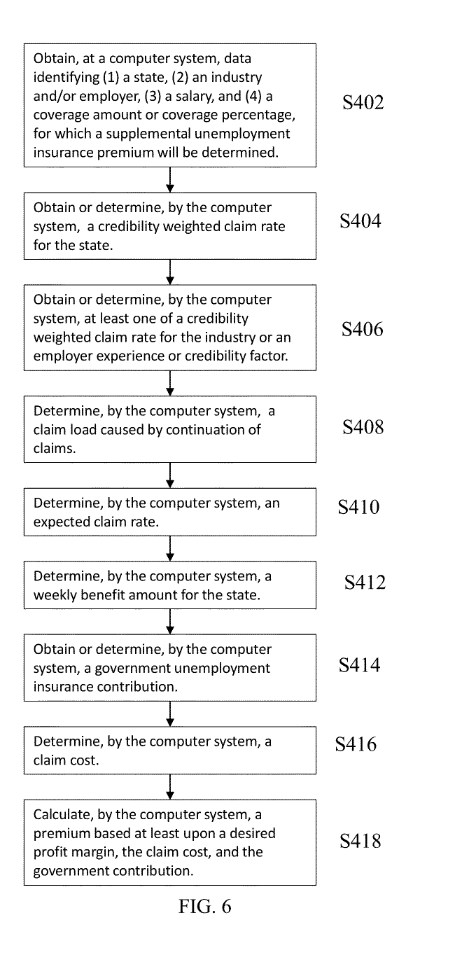

FIG. 6 is a flow chart illustrating a method for calculating premium rates for supplemental unemployment insurance according to another exemplary embodiment of the present invention. In step S402 of the process, the computer system 110 obtains data identifying the state, industry and/or employer, salary and coverage amount or coverage percentage for which a supplemental unemployment insurance premium will be determined. In this step, the unemployment insurance policy module 224 may receive an application from an employer for a PUI group policy for its employees. Data regarding the applicant may be collected directly from the applicant along with data accessed from internal and/or external databases, such as state and/or federal databases, to generate a profile for the applicant and determine eligibility. In this regard, the applicant may select basic, moderate or comprehensive levels of coverage, with each level providing a respective total percentage of original income coverage. For example, basic coverage may provide 50% total coverage, moderate coverage may provide 60% total coverage and comprehensive coverage may provide 75% total coverage, although any other coverage percentages may be possible.

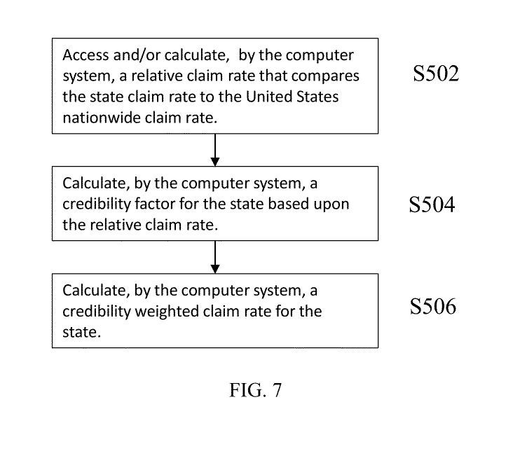

In step S404, the computer system 110 calculates a credibility weighted claim rate for the state in which the applicant is employed. In this step, the claim rate for the state is weighted according to a state credibility factor, which uses the state's past claim history as an indication of the level of risk involved and the likelihood that future claims will be filed. Once a risk level is determined, the credibility factor is measured against a baseline pricing rate that represents the average rate charged to a class of policyholders that have similar characteristics. FIG. 7 is a flowchart illustrating a method of calculating a state credibility weighted claim rate according to an exemplary embodiment of the present invention.

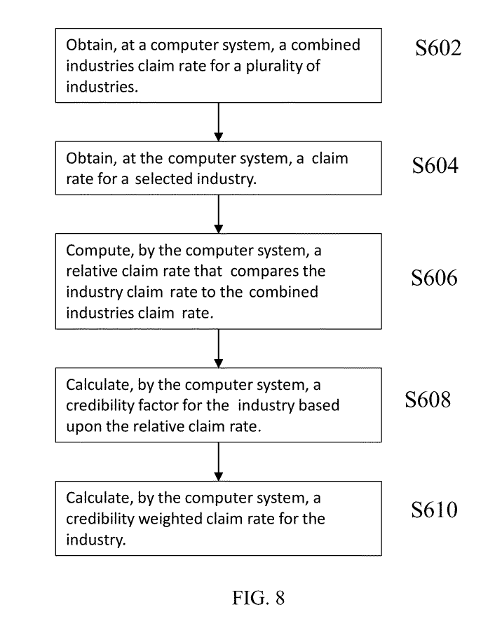

In step S406, the computer system 110 determines at least one of a credibility weighted claim rate for the industry or an employer experience or credibility factor. In this step, the claim rate for the industry may be weighted according to an industry credibility factor and/or an experience rating of the applicant that takes into account hiring, firing, termination and lay-offs of the applicant over a predetermined period of time (e.g., during the entire history of the applicant), as well as external factors such as industry and economic environment, may be calculated. The experience rating may be a percentage that indicates the employer's likelihood to lay off employees. In embodiments, the employer rating may incorporate projections about the likelihood of a layoff within a future time period, such as half a year, one year, 4 years, to name a few. Such projections may be based upon historical data, which may relate the employer's actions regarding layoffs to other economic or market conditions (e.g., stock price, cash flows, national unemployment statistics, to name a few). FIG. 8 is a flowchart illustrating a method of calculating an industry credibility weighted claim rate according to an exemplary embodiment of the present invention.

In step S408, the computer system 110 determines a claim load caused by continuation of the claims. In this step, the possibility of claims persisting without the claimant resuming work are taken into consideration in calculating the premium rate. FIG. 9 is a flowchart illustrating a method of determining state continuation load according to an exemplary embodiment of the present invention.

In step S410, the computer system 110 calculates an expected claim rate. In this step, an expected claim rate may be based on one or more of following: claim rate across all industries (which provides a baselines claim rate), a credibility weighted claim rate for the selected industry, a credibility weighted claim rate for the selected state or an employer experience or credibility factor. Accordingly, the expected claim rate may be calculated as follows:

$${ClaimRate}_{Expected} = {ClaimRate}_{All Industries} * {ClaimRate}_{IndustryCredibilityWeighted} * {ClaimRate}_{StateCredibilityWeighted} * EmployerRating \qquad ( 1 )$$

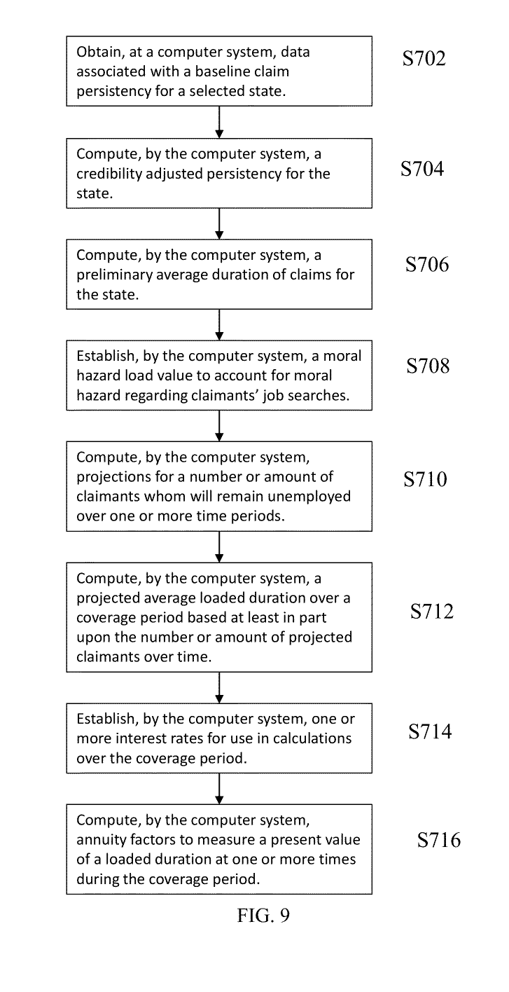

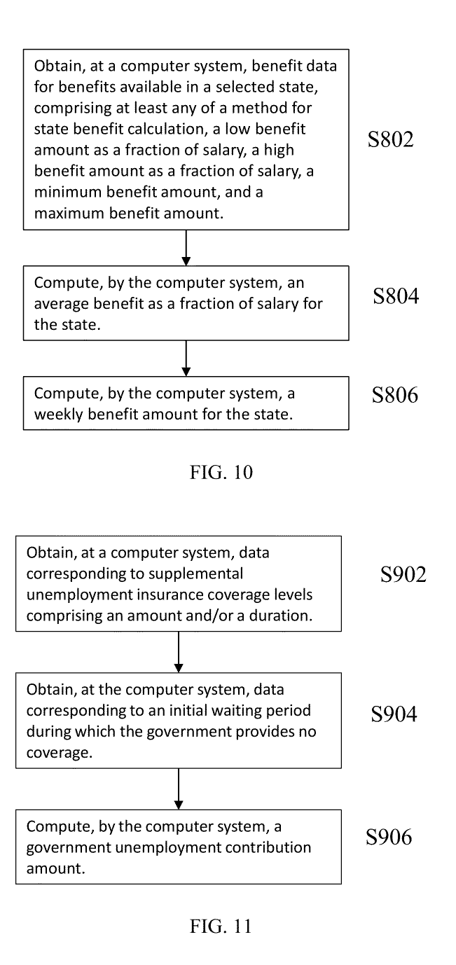

In step S412, the computer system 110 calculates a weekly benefit amount for the state. FIG. 10 is a flowchart illustrating a method for calculating a weekly benefit amount for a state according to an exemplary embodiment of the present invention.

In step S414, the computer system 110 calculates a government unemployment insurance contribution. FIG. 11 is a flowchart illustrating a method for calculating a government unemployment insurance contribution according to an exemplary embodiment of the present invention.

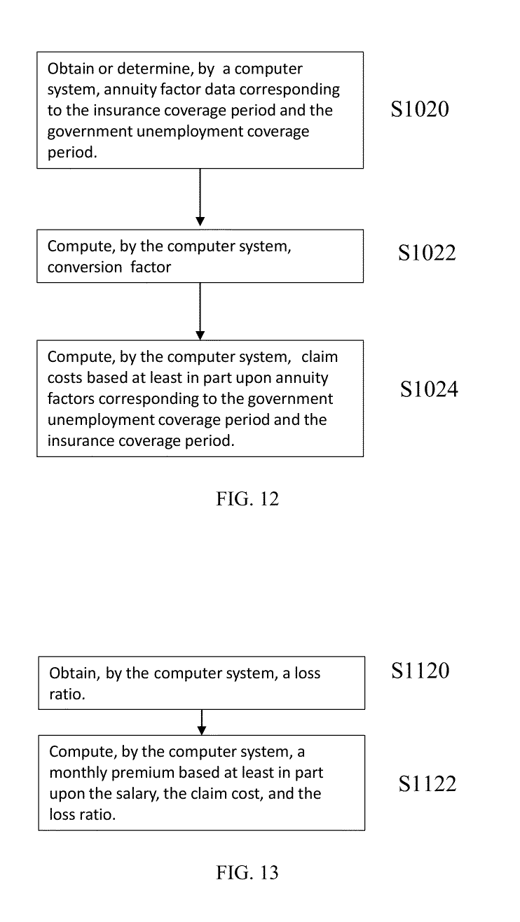

In step S416, the computer system 110 calculates a claim cost based on the expected claim rate calculated in step S410 and the government unemployment insurance contribution calculated in step S414. FIG. 12 is a flowchart illustrating a method for calculating a claim cost according to an exemplary embodiment of the present invention.

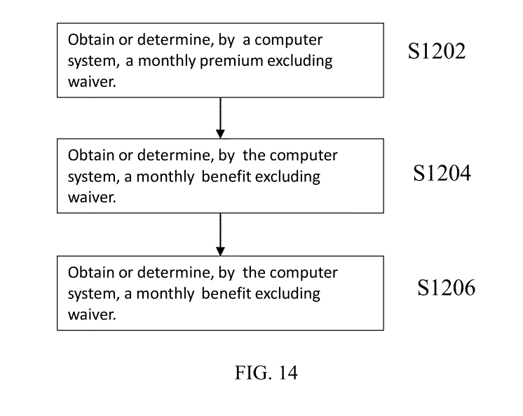

In step S418, the computer system 110 calculates a premium payment based on at least a desired profit margin, the claim cost and the government contribution. FIG. 13 is a flowchart illustrating a method for calculating a premium payment with no waiver according to an exemplary embodiment of the present invention and FIG. 14 is a flowchart illustrating a method for calculating a premium payment with waiver according to an exemplary embodiment of the present invention.

Referring back to FIG. 7, which illustrates a method of calculating a state credibility weighted claim rate according to an exemplary embodiment of the present invention, the computer system 110 accesses the selected state's relative claim rate from a database of available data in step S502. The relative claim rate of the states is based on the assumption that the U.S. has a claim rate average of 100%. Alternatively, the computer system 110 may calculate the state relative claim rate by accessing state claim rate data and comparing to the U.S. nationwide claim rate. In step S504, the computer system 110 calculates a state credibility factor based on the state relative claim rate. The state credibility factor may be calculated as follows:

CredibilityFactor_{State}=(1−|log₁₀ ClaimRate_{RelativeState}|*100%) with a floor of 10% (2)

In step S506, the state's credibility weighted rate may then be calculated as follows:

$${ClaimRate}_{StateCredibilityWeighted} = {ClaimRate}_{StateRelative} * {CredibilityFactor}_{State} + ( 1 - {CredibilityFactor}_{State} ) \qquad ( 3 )$$

Referring back to FIG. 8, which illustrates a method of calculating an industry credibility weighted claim rate according to an exemplary embodiment of the present invention, the computer system 110 accesses a combined industries claim rate from a database of available data in step S602. The combined claim rate is taken as the baseline claim rate. In step S604, the computer system 110 accesses the claim rate for the selected industry from the claim rate database. In step S606, the computer system 110 calculates the relative claim rate for the selected industry with respect to the claim rate from across all industries based on the following formula:

$${ClaimRate}_{industryRelative} = \frac{{ClaimRate}_{industry`}}{{ClaimRate}_{All industries}} \qquad ( 4 )$$

In step S608, the industry's credibility factor is then calculated based on the calculated relative claim rate as follows:

CredibilityFactor_{Industry}=(1−|log₁₀ ClaimRate_{IndustryRelative}|*100%) with a floor of 10% (5)

In step S610, the computer system 110 then calculates a credibility weighted claim rate for the industry as follows:

$${ClaimRate}_{IndustryCredibilityWeighted} = {ClaimRate}_{IndustryRelative} * {CredibilityFactor}_{Industry} + ( 1 - {CredibilityFactor}_{Industry} ) \qquad ( 6 )$$

Referring back to FIG. 9, which illustrates a method of determining state continuation load according to an exemplary embodiment of the present invention, the computer system 110 in step S702 accesses a database of available data related to a baseline claim persistency for the selected state. In step S704, the computer system 110 calculates a credibility adjusted persistency for the selected state using the state's credibility factor as determined in step S504 as follows:

Persistency_{CredibilityAdjusted}=Persistency_{Baseline}*Credibility_{FactorState}+(1−CredibilityFactor_{State})*Persistency_{UnitedStatesBase} (7)

In step S706, the computer system 110 calculates the state's preliminary average duration as follows:

$$PrelimAvgDuration = \frac{1 - {( {Persistency}_{CredibilityAdjusted} )}^{26}}{\frac{1}{{Persistency}_{CredibilityAdjusted}} - 1} \qquad ( 8 )$$

In step S708, a moral hazard load value is set to adjust for the possibility that people may tend to change their behavior after they have purchased the lay-off insurance coverage and anticipate payment of benefits. For example, claimants may not look for a new job immediately. The load value may be a number of weeks for which insured claimants are projected to remain unemployed, and the moral hazard load value may represent an initial period of time during which claimants have not yet obtained new jobs.

In step S710, the computer system 110 calculates the projected percentage of claimants remaining unemployed each week over a period of time (i.e., over a period of 4 years). During the initial moral hazard period set in step S708, 100% are projected to remain unemployed. Thereafter, for each week, the weekly percentage unemployed may be calculated as follows:

PercentUnemployed_{Weekly}=PercentUnemployed_{PreviousWeek}*CredibilityAdjustedPersistency (9)

In step S712, the computer 110 calculates an average loaded duration by summing the weekly percentage unemployed over the coverage period, including the moral hazard period. The coverage period may be calculated as half a year minus the moral hazard load value (e.g., 26 weeks−2 weeks=24 weeks). The average loaded duration may be calculated as follows:

AvgLoadedDuration=Σᵢ₌₃²⁶ PercentUnemployed_{Week}_{ᵢ} (10)

The average load duration is the average length of unemployment by state. A direct relationship may be set between the length of unemployment and the premium rate, so that the longer the average load duration, the higher the premium.

In step S714, an annual interest rate I is set for use in calculating annuity factors. For example, a 5% (or other applicable) annual interest rate may be used as a discount rate and summed to develop an unemployed annuity factor in step S716. The annuity factors are the net present value of the number of people unemployed. An annuity factor may be calculated for each week of the coverage period as follows:

$${AnnuityFactorWeek}_{i} = {\sum }_{t = 0}^{208} \frac{ }{{( 1 + {AnnuityFactor}_{initial} )}^{t}} \qquad ( 11 )$$

where t=i−1 and

$${AnnuityFactor}_{initial} = \frac{1}{{( 1 + I )}^{52}} - 1 ,$$

where I is the annual interest rate

Referring back to FIG. 10, which illustrates a method for calculating a weekly benefit amount for a state according to an exemplary embodiment of the present invention, the computer system 110 in step S802 accesses available data to determine benefits for a selected state. For example, a database may be accessed that provides, for each state, a method for state benefit calculation (e.g., 2Q, 2.5Q, 4Q or HQ), a low benefit amount as a fraction of salary, a high benefit amount as a fraction of salary, a minimum benefit amount and a maximum benefit amount. In step S804, the computer system 110 calculates the state average fractional weekly benefit as follows:

$$\begin{matrix}If 2 Q , StateAvgFractionalBenefit = \frac{( LowFraction + HighFraction )}{2} * \frac{1}{2} & ( 12 ) \\ If 2.5 Q , StateAvgFractionalBenefit = \frac{( LowFraction + HighFraction )}{2} * \frac{1}{1.6} & ( 13 ) \\ If 4 Q , StateAvgFractionalBenefit = \frac{( LowFraction + HighFraction )}{2} & ( 14 ) \\ If HQ , StateAvgFractionalBenefit = \frac{( LowFraction + HighFraction )}{2} * \frac{1}{4} & ( 15 )\end{matrix}$$

In step S806, the computer system 110 then calculates the state's weekly benefit as follows:

StateWeeklyBenefit=min{(StateAvgFractionalBenefit*AnnualSalary),(StateMaxBenefit)} (16)

Referring back to FIG. 11, which illustrates a method for calculating a government unemployment insurance contribution according to an exemplary embodiment of the present invention, the computer system 110 at step S902 establishes coverage levels comprising an amount and a duration. In this regard, the coverage amounts are the percentage of total original income that the insurance company will pay, and may be, for example, 50%, 60%, 75% or some other percentage and the coverage duration is the duration (for example, 24 weeks or some other time period) of payments. In step S904, an initial wait period is established during which no coverage is provided by the government nor the insurance company (e.g., 3 weeks). In step S906, the computer system 110 calculates the government unemployment contribution amount, as a percent of the total coverage, as follows:

$${GovAmt}_{\%} = \frac{StateWeeklyBenefit * 52 weeks}{AnnualSalary} * \frac{1}{{CoverageAmt}_{\%}} \qquad ( 17 )$$

Referring back to FIG. 12, which illustrates a method for calculating a claim cost according to an exemplary embodiment of the present invention, the computer system in step S1020 re-computes or accesses the annuity factor data already computed in step S716 (formula (11)) to determine the following annuity factors:
AnnuityFactor_{WaitPeriod}—e.g., annuity factor for week 3
AnnuityFactor_{WaitPeriod+GovCoveragePeriod}—e.g., annuity factor for week 27 (3 week wait period+24 week government unemployment coverage period)
AnnuityFactor_{WaitPeriod+InsuranceCoveragePeriod}—e.g., annuity factor for week 27 (3 week wait period+24 week insurance coverage period)

In step S1022, the computer system 110 calculates a conversion factor as follows:

ConversionFactor=(AnnuityFactor_{WaitPeriod}−AnnuityFactor_{WaitPeriod+InsuranceCoveragePeriod})*CoverageAmt_{%}−(AnnuityFactor_{WaitPeriod}−AnnuityFactor_{WaitPeriod+GovCoveragePeriod})*GovAmt_{%}*CoverageAmt_{%} (18)

In step S1024, the computer system 110 calculates claim cost as a percentage of salary (weekly cost per $1 of salary excluding profits and expenses), i.e., the net premium rate, as follows:

$$ClaimCost = \frac{{ClaimRate}_{Expected} * ConversionFactor}{52 weeks} \qquad ( 19 )$$

Referring back to FIG. 13, which illustrates a method for calculating a premium payment with no waiver according to an exemplary embodiment of the present invention, the computer system 110 at step S1120 establishes a loss ratio (e.g., 49% or some other percentage). At step S1122, the computer system 110 calculates monthly premium excluding waiver benefit as follows:

$${Premium}_{MonthlyNoWaiver} = \frac{AnnualSalary * ClaimCost}{LossRatio} * \frac{1}{12} \qquad ( 20 )$$

The computer system 110 may also calculate monthly insurance benefit excluding waiver as follows:

$${Benefit}_{MonthlyNoWaiver} = \frac{AnnualSalary}{12 months} * CoverageAmt * ( 1 - GovAmt ) \qquad ( 21 )$$

Referring back to FIG. 14, which illustrates a method for calculating a premium payment with waiver according to an exemplary embodiment of the present invention, the computer system at step S1202 calculates additional cost as % of claims as follows:

$$AdditionalCost = \frac{{Premium}_{MonthlyNoWaiver}}{{Benefit}_{MonthlyNoWaiver}} \qquad ( 22 )$$

In step S1204, the computer system 110 calculates a premium multiplier as follows:

$$PremiumMultiplier = \frac{1}{1 - AdditionalCost} \qquad ( 23 )$$

In step S1206, the computer system 110 then calculates monthly premium waiver as follows:

Premium_{MonthlyWithWaiver}=Premium_{MonthlyNoWaiver}*PremiumMultiplier (24)

### Example 1

In this section, a sample method for calculating premium rates is provided though not all aspects or embodiments need employ the example method. For each step, a detailed explanation is given of the quantities involved and how they may be extracted from available data. For purposes of this example, example rates for Washington, D.C. for the year 2013 will be addressed.

As a first step, data related to an applicant for employer-based supplemental unemployment insurance is input to the PUI provider computer system 110 through the graphical user interface. In this example, the input data includes the following:

| | |
|---|---|
| Annual Salary | 80,000 |
| State | District of Columbia |
| Industry | min = mining |
| Employer Experience | 95% |
| Rating Factor | |
| Coverage Level to Display | Basic |
| in Rate Tables | |
| Loss Ratio | 49% |
| Include Waiver Benefit | Yes |
| (Yes/No) | |

In this example, the basic coverage provides 50% coverage of the original income in total for a period of 24 months.

The computer system 110, and in particular the unemployment insurance policy module 224, then begins calculation of the monthly payment and benefit amounts. The computer system 110 calculates a credibility weighted claim rate for Washington, D.C. based on the state relative claim rate and the state credibility factor. The relative claim rate for Washington D.C. is accessed from a database of available data. In this example, the state-specific data is accessed from the following government website:

http://workforcesecurity.doleta.gov/unemploy/content/data_stats/datasum13/DataSum_{—}2013_{—}3.pdf.

The computer system 110, using formula (2), then calculates a state credibility factor, which in this example is determined to be 96% based on an input of 110.5% for the previously determined relative claim rate. The credibility weighted claim rate for Washington, D.C. is then computed using formula (3) to be 110.1%.

The computer system 110 calculates an industry credibility weighted claim rate based on the industry relative claim rate and the industry credibility factor. In this example, the relative claim rate for the applicant's industry, which in this case is mining, is accessed from the following government website:

http://workforcesecurity.doleta.gov/unemploy/chariu/dstrpt.asp

The computer system 110, using formula (4), calculates the mining industry relative claim rate, which in this example is determined to be 12.5% based on input values of 5.6% for all industries claim rate and 2.6% for the mining industry claim rate.

The computer system 110, using formula (5), calculates the mining industry's credibility factor, which in this example is determined to be 67% based on an input value of 12.5% for the previously calculated mining industry relative claim rate. The mining credibility weighted claim rate is then calculated using formula (6) and is determined by the computer system 110 to be 64.3% using input values of 12.5% for the previously calculated mining industry relative claim rate and 67% for the previously calculated mining industry credibility factor.

The computer system 110 calculates continuation load for Washington, D.C. by first accessing baseline claim persistency data for Washington D.C. from the previously mentioned government website. In this example, the baseline claim persistency for Washington D.C. is 97.5%. The computer system 110, using formula (7), then calculates a credibility adjusted persistency, which in this example is determined to be 97.43% based on input values of 97.5% for the previously determined baseline claim persistency and 96% for the previously calculated state credibility factor.

The computer system 110, using formula (8), calculates the preliminary average duration for Washington, D.C., which in this example is determined to be 18.64 weeks based on an input value of 97.43% for the previously calculated credibility adjusted persistency.

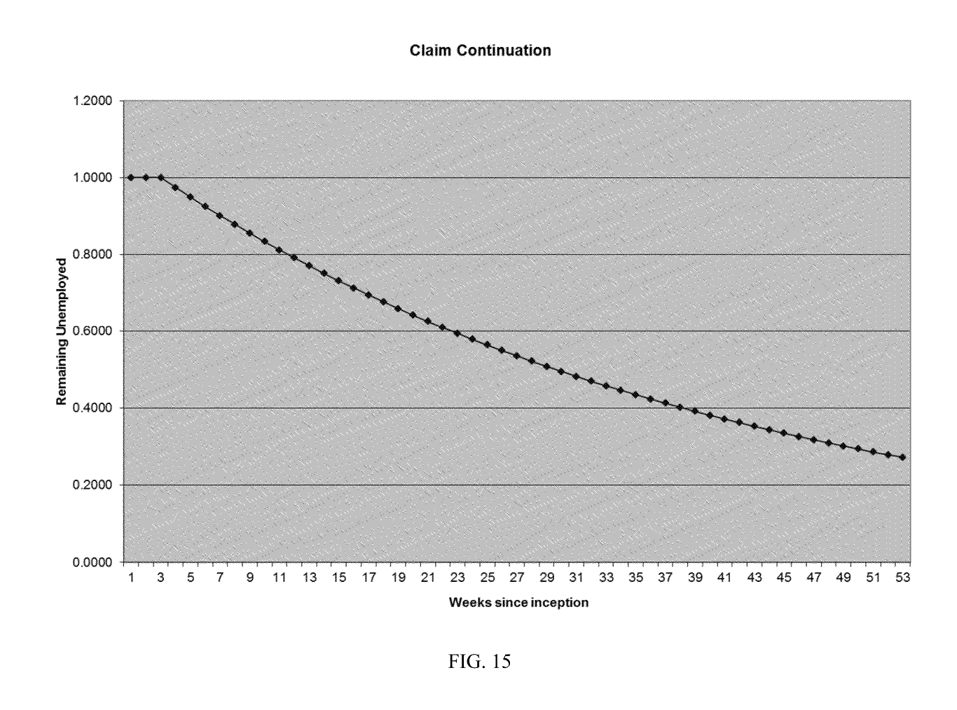

The computer system 110, using formula (9), then calculates the weekly percentage unemployed for Washington, D.C., which in this example is shown in FIG. 15 based on initial input values of 100% unemployed for the first 2 weeks (i.e., the moral hazard load in this example is 2 weeks) and 97.43% for the previously calculated credibility adjusted persistency.

The computer system 110, using formula (10), calculates an average load duration, which in this example is determined to be 19.61 weeks based on input values for the previously calculated weekly percentage unemployed.

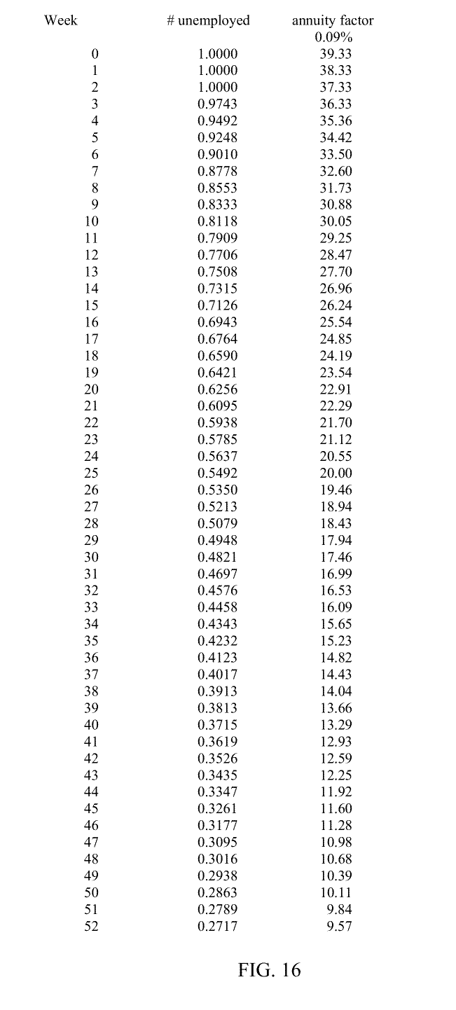

The computer system 110, using formula (11), calculates an annuity factor for each week of the coverage period, which in this example is shown in FIG. 16 based on an input value of 5% for the annual interest rate.

The computer system 110, using formula (16), then calculates Washington, D.C.'s weekly benefit which in this example is determined to be $359 based on input values for state average fractional weekly benefit as calculated using the HQ method, and input values of 0.0385 for low benefit amount, 0.0385 for high benefit amount, 50$ for minimum benefit amount and $359 for high benefit amount.

The computer system 110, using formula (17), then calculates the government unemployment contribution amount, which in this example is determined to be 47% using input values of $359 for the previously calculated state weekly benefit, 50% for coverage amount (for basic coverage) and $80,000 for annual salary.

The computer system 110, using formula (18), then calculates a conversion factor, which in this example is determined to be 4.638 using input values for the previously calculated annuity factors, coverage amount and government unemployment contribution amount.

The computer system 110, using formula (19), then calculates claim cost, which in this example is determined to be 0.477% using input values of 5.34% for expected claim rate (as calculated using formula (1)) and 4.638 for the previously calculated conversion factor.

In this example, since the applicant chose the waiver benefit, the computer system 110 must first determine the monthly premium and benefit in the case of no waiver. In this regard, the computer system 110, using formula (20), calculates a monthly premium payment with no waiver benefit, which in this example is determined to be $64.84 using input values of $80,000 for annual salary, 0.477% for claim cost and 49% for loss ratio.

The computer system 110, using formula (21), then calculates monthly insurance benefit excluding waiver, which in this example is determined to be $1,777.67 using input values of $80,000 for annual salary, 50% for coverage amount and the previously calculated government contribution amount.

The computer system 110, using formula (22), calculated additional cost associated with the waiver, which in this example is determined to be 3.65% using input values of $64.84 for the previously calculated monthly premium with no waiver and $1,777.67 for the previously calculated monthly benefit with no waiver.

The computer system 110, using formula (23), calculates a premium multiplier, which in this case is determined to be 103.79% using an input value of 3.65% for the previously calculated additional cost.

The computer system 110, using formula (24), then calculates monthly premium with waiver, which in this example is determined to be $67.30 using as input values $64.84 for the previously calculated monthly premium with no waiver and 103.79% for the previously calculated premium multiplier.

### Example Implementation

The methods described above can be practiced in various ways. The system 100 may comprise one or more servers, one or more remote terminal devices and a data communications network to allow them to intercommunicate. The data communications network may comprise any suitable communications network such as, but not limited to, the global internet, an organizational intranet, a wireless network, or some combination of the foregoing. The example will principally rely on the network being the global internet. At least one of the servers may be a web server that delivers up web pages (formatted, e.g., in a version of HTML or XHTML or another markup language) in response to input from one of the terminals (which may be any kind of data communications devices), and a server or other computer which executes one or more computer programs that operate as described herein to (a) issue a policy and/or (b) process an unemployment claim. System 100 preferably includes one or more databases. The databases may be localized or distributed and stored in the storage medium of a server or elsewhere. One or more of the databases may be maintained by a state government or federal government agency. Server delivers through an internet connection to a terminal, for example, website pages generated by the application and viewed on, for example, an internet browser at terminal 206. The remote terminal may interact with the server, through a standardized communications protocol such as the HTTP protocol, to allow a server to request information and supply output or, conversely, a user to supply input and receive output.

On one or more pages delivered up by the server and appearing in the user's browser, a request for input data will be presented and input data will be received. Such data may include, for example, the name and address of the insurance applicant, telephone number, e-mail address, industry, occupation and federal ID number, to name a few. In the case of the industry and occupation information, it may desirable to first obtain general information and then more specific information dependant upon the general information. For example, pull down menus may be used to allow selection of a general industry category and once the entry on that menu has been selected, a sub-menu may be provided in which there is a further pull down list.

Certain of the input data preferably may be verified against commercially or generally available databases, such as, for example, to confirm the applicant-employer name, address, industry and telephone number. The server may check for blank or incomplete responses and prompt the user to supply requested information.

In some embodiments, one or more pages may be presented to solicit information of the type discussed above, to permit an underwriting analysis to be performed and a premium to be generated, if coverage criteria are met. A typical list of questions and data requests, for example, might be as follows:
i. Does your company consist of at least 50 employees? Y/N checkboxes
ii. Average number of month that employees have worked at company? (Small text box to fill in number between 0 and 600)
iii. Average of previous year's wages?
iv. Do you know that any of your employees will become unemployed or have any reason to believe that any of your employees may become unemployed? Y/N checkboxes
v. Have any of your employees been involuntarily unemployed or collected state unemployment insurance benefits in the last 3 years? Y/N checkboxes
vi. Are any of your employees in a casual, temporary or seasonal employment (including casual, temporary or seasonal contracts) or in any type of occupation where unemployment is a regular feature of that particular job? Y/N checkboxes
vii. Are any of your employees a Contract Worker and Employed under a fixed term contract of Employment (i.e. you receive 1099 and not a W2), or the expiry of an apprenticeship or training contract? Y/N checkboxes
viii. Have any of your employees been convicted of a fraud related felony crime in the past 10 years? Y/N checkboxes, if Y is checked a text box will open underneath, headed by “If yes to the above question, please explain here.”
ix. Is company involved in any bankruptcy proceedings? Y/N checkboxes. The input data may be tested against predetermined criteria and in some events, the applicant may be declined insurance. Some answers may prompt further questions or human intervention. As examples, for iii) if the answer is below some threshold dollar amount, a page may display, saying that the applicant is not qualified for the policy at this time. Other disqualifications might be a negative answer to iv), an affirmative answer to v)-vii) or ix). Further, an insurer might not offer this insurance to a company of fewer than 50 (or some other number of) employees.

If no flags were raised, then the server may proceed automatically to generate a premium offer. If no flags were raised, signifying a need for more information or human attention, a premium is generated, then an offer may be sent to the user's remote terminal from the server, indicating the premium and providing an opportunity for the applicant-employee to accept the policy. Further screens may manage the payment process, such as a charge to a credit card account.

### The Claims Process

One of the advantageous repercussions of setting the claims period of the product to only be in force concurrently with the state's established program, is the ease of verifying claims. By “piggybacking” on top of the state's existing unemployment verification process, claims verification becomes merely payment verification (i.e., instead of having a claims adjuster look over paperwork proving a layoff, and checking in every payment period to see if the laid-off worker has a new job yet, the state can do that work for the insurer, and the insurer just has to verify that the state has authorized a weekly or bi-weekly payment to the insured). This is only possible in a pure supplement policy, where the conditions for payments match those of the state.

If a state agency will grant a private insurer access to its claims verification or payment data, then it is possible for the beneficiary to make a claim on-line and for the insurer's computer system to query the state database for verification of the claim, and to authorize payment to the insured. The data required from the state may not just be a yes/no determination, but the amount of benefit being paid to the worker. This is needed to compute the supplemental benefit the worker is owed.

Verification, in some embodiments, may have two stages, and can be done in several ways.

### Stage 1

The notice from the state is received by the insurer, with a determination of benefits. This puts the insurer on notice for an impending claim.

### Stage 2

A ledger of all payments from the state is kept, in order to accurately supplement the proper payments, since there is a waiting period of some weeks from the first unemployment benefit. Sufficient proof of payment could be:
(1) The original or copy of the periodic check sent to the claimant, or
(2) The original or copy of a bank statement, if it was a direct deposit, or
(3) Electronic payment status from state records.

Payments can be made in any acceptable form, such as direct deposit in a bank account, or to state funded debit account.

### Cyclicality

Unemployment insurance claim experience may be subject to macroeconomic forces. During an improving business climate, at the top of the business cycle, and perhaps partway into a downturn, the number of layoffs each week will decrease. During slowdowns, at the bottom of the business cycle, and perhaps partway into the upturn, unemployment insurance claims will increase each week. This will lead to similar trends for the rate at which people apply for the extended unemployment benefits. In improving sections of the economic cycle, business should be slower than during recessions when workers will immediately sense the need for insurance benefits.

For unemployment insurance, other economic forces may likely oppose the ebb and flow of the economic cycle. Prospective applicants will be less likely to purchase insurance at the times they need it most. At times of economic stability, the prospect of a layoff will receive little attention. Insureds will be more likely to buy when they need it least, at the bottom of the cycle. During times of economic instability, when the prospect of a layoff seems highest, in actuality, most of the layoffs have already occurred. The “backwards” nature of demand for unemployment insurance stems from the inherent long term nature of jobs tenures and unemployment lengths.

In other words, unemployment insurance should be more profitable during times of economic instability. This should be attractive to insurers who, by offering a proper mix of coverage, including unemployment insurance, may be able to diversify its portfolio of coverage. This should lead to more consistent premium revenues when viewed over the course of a business cycle being more profitable in a broader range of times.

Furthermore, a statistical analysis of Department of Labor data covering the period 1998 through 2002 shows that cyclicality may not be as extreme as many might believe. It was found that peak claim rates were less than 1.5 times claim rates at the trough.

There are a number of foreseeable uses or adaptations of the system and methods above-discussed, besides that of PUI.

According to one variation, a personal financial services product may be provided as part of a portfolio of investments and annuities. Currently, financial services firms generally advise clients on smoothing their cash flow for foreseeable life events where income diminishes, like retirement; or where expenses increase, like for children's college funds. However, smoothing short term income shortfalls is generally not possible, though it should be a key aspect of a stable portfolio. There exist products for some completely unforeseeable catastrophic events such as disability or loss of business continuity. PUI will provide added financial security protecting a middle or high income individual for this somewhat expectable calamity.

With some small modifications, this product can be used as a tradable derivative, to allow sophisticated investors to invest, speculate or hedge on the future probability in unemployment, including unemployment in particular industries, occupations, and geographic locations such as states.

Having thus presented underlying concepts of the methods and systems in connection with which some implementations have been discussed by way of example only, it will now be understood that various other embodiments and uses will occur to those skilled in the art, all of which are intended to be within the spirit and scope of the invention. The claims define various aspects of the invention and it will be further understood that not all aspects of the invention are necessarily practiced in a given instance. An embodiment may practice one or more aspects of the invention. Accordingly, the examples shown are for purposes of illustration and not limitation.

What is claimed is:

1. A method for providing supplemental unemployment insurance comprising:
receiving, by a computer system, applicant data associated with an applicant for a group unemployment insurance policy that provides supplemental unemployment insurance to one or more beneficiaries, the applicant data comprising at least the following:
1) salary data associated with salary information for each of the one or more beneficiaries;
2) state data associated with state of residence information of the applicant;
3) industry data associated with industry information for the applicant;
4) applicant experience data associated with an experience rating factor for the applicant;
5) coverage level data associated with a coverage level to be provided to each of the one or more beneficiaries;
6) loss ratio data associated with a loss ratio of a provider of the group unemployment insurance policy;
7) waiver selection data associated with a waiver benefit provided to each of the one or more beneficiaries; and
8) annual interest rate data associated with a discount rate;
for each of the one or more beneficiaries, calculating, by the computer system, premium payment data using the following algorithm:
at least one of accessing or calculating, by the computer system, state relative claim rate data based on the state data;
calculating, by the computer system, state credibility factor data based on the at least one of the accessed or calculated state relative claim rate data;
calculating, by the computer system, state credibility weighted claim rate data based on the at least one of accessed or calculated state relative claim rate data and the calculated state credibility factor;
at least one of accessing or calculating, by the computer system, industry relative claim rate data based on the industry data;
calculating, by the computer system, industry credibility factor data based on the at least one of accessed or calculated industry relative claim rate;
calculating, by the computer system, industry credibility weighted claim rate data based on the at least one of accessed or calculated industry relative claim rate data and the calculated industry credibility factor;
calculating, by the computer system, expected claim rate data based on the calculated state credibility weighted claim rate data, the calculated industry credibility weighted claim rate data and the applicant experience data;
calculating, by the computer system, claim cost data based at least on the calculated expected claim rate data and the coverage level data; and
calculating, by the computer system, premium payment data based at least on the calculated claim cost data, the loss ratio data, the annual salary data and the waiver selection data; and
providing, by the computer system to an applicant computer system, group unemployment insurance policy data comprising the periodic premium payment data.

2. The method of claim 1, further comprising the steps of:
accessing, by the computer system, state claim persistency data and nationwide persistency data;
calculating, by the computer system, state credibility adjusted persistency data based on the calculated state credibility factor and the accessed state persistency data and nationwide persistency data;
calculating, by the computer system, state preliminary average duration data based on the calculated state credibility adjusted persistency;
calculating, by the computer system, projected percentage unemployed data associated with projected percentage of claimants remaining unemployed each claim period over a period of time, based at least on the calculated state credibility adjusted persistency; and
calculating, by the computer system, average loaded duration data based on the calculated projected percentage unemployed data.

3. The method of claim 2, further comprising:
calculating, by the computer, for each claim period, annuity factor data based on the annual interest rate data.

4. The method of claim 3, further comprising:
accessing, by the computer system, state benefit data comprising at least one or more of the following:
1) method data associated with a method for calculating a state benefit;
2) low benefit amount data associated with a low benefit amount as a fraction of salary;
3) high benefit amount data associated with a high benefit amount as a fraction of salary;
4) minimum benefit amount data associated with a minimum state benefit amount; and
5) maximum benefit amount data associated with a maximum state benefit amount;
calculating, by the computer system, state average fractional benefit data based on the accessed state benefit data; and
calculating, by the computer system, state benefit amount data based on the calculated state average fractional benefit data, the annual salary data and the maximum state benefit amount data.

5. The method of claim 4, further comprising:
calculating, by the computer system, government unemployment contribution amount data based on the calculated state benefit amount data, the annual salary data and the coverage level data.

6. The method of claim 5, further comprising:
calculating, by the computer system, conversion factor data associated with a conversion factor, based on the annuity factor data, the coverage level data and the calculated government unemployment contribution amount data, wherein
the step of calculating, by the computer system, the claim cost data is further based on the calculated conversion factor data.

7. The method of claim 5, further comprising:
calculating, by the computer system, benefit amount data based on the salary data, the coverage level data and the government unemployment contribution amount data.

8. The method of claim 7, wherein, upon the condition that the waiver selection data indicates that a waiver benefit is applicable, the method further comprises:
calculating, by the computer system, additional cost data based on the calculated benefit amount data and the calculated premium payment data;
calculating, by the computer system, premium multiplier data based on the additional cost data; and
re-calculating, by the computer system, the premium payment data based on the original calculated premium payment data and the premium multiplier.

9. The method of claim 1, further comprising:
receiving, by the computer system, request data associated with a request by at least one of the one or more beneficiaries for a supplemental unemployment insurance benefit under the group unemployment insurance policy; and
determining, by the computer system, eligibility of the at least one of the one or more beneficiaries for receipt of the supplemental unemployment insurance benefit.

10. The method of claim 9, wherein the step of determining eligibility is based on whether a state has determined that the at least one of the one or more beneficiaries is eligible for a state unemployment insurance benefit.

11. A system for providing supplemental unemployment insurance comprising:
one or more data processing apparatus; and
a non-transitory computer-readable medium coupled to the one or more data processing apparatus having instructions stored thereon which, when executed by the one or more data processing apparatus, cause the one or more data processing apparatus to perform a method comprising:
receiving applicant data associated with an applicant for a group unemployment insurance policy that provides supplemental unemployment insurance to one or more beneficiaries, the applicant data comprising at least the following:
1) salary data associated with salary information for each of the one or more beneficiaries;
2) state data associated with state of residence information of the applicant;
3) industry data associated with industry information for the applicant;
4) applicant experience data associated with an experience rating factor for the applicant;
5) coverage level data associated with a coverage level to be provided to each of the one or more beneficiaries;
6) loss ratio data associated with a loss ratio of a provider of the group unemployment insurance policy;
7) waiver selection data associated with a waiver benefit provided to each of the one or more beneficiaries; and
8) annual interest rate data associated with a discount rate;
for each of the one or more beneficiaries, calculating premium payment data using the following algorithm:
at least one of accessing or calculating state relative claim rate data based on the state data;
calculating state credibility factor data based on the at least one of accessed or calculated state relative claim rate data;
calculating state credibility weighted claim rate data based on the at least one of accessed or calculated state relative claim rate data and the calculated state credibility factor;
at least one of accessing or calculating industry relative claim rate data based on the industry data;
calculating industry credibility factor data based on the at least one of the accessed or calculated industry relative claim rate;
calculating industry credibility weighted claim rate data based on the at least one of accessed or calculated industry relative claim rate data and the calculated industry credibility factor;
calculating expected claim rate data based on the calculated state credibility weighted claim rate data, the calculated industry credibility weighted claim rate data and the applicant experience data;
calculating claim cost data based at least on the calculated expected claim rate data and the coverage level data; and
calculating premium payment data based at least on the calculated claim cost data, the loss ratio data, the annual salary data and the waiver selection data; and
providing, to an applicant computer system, group unemployment insurance policy data comprising the periodic premium payment data.

12. The system of claim 11, wherein the method further comprises:
accessing state claim persistency data and nationwide persistency data;
calculating state credibility adjusted persistency data based on the calculated state credibility factor and the accessed state persistency data and nationwide persistency data;
calculating state preliminary average duration data based on the calculated state credibility adjusted persistency;
calculating projected percentage unemployed data associated with projected percentage of claimants remaining unemployed each claim period over a period of time, based at least on the calculated state credibility adjusted persistency; and
calculating average loaded duration data based on the calculated projected percentage unemployed data.

13. The system of claim 11, wherein the method further comprises:
calculating for each claim period, annuity factor data based on the annual interest rate data.

14. The system of claim 13, wherein the method further comprises:
accessing state benefit data comprising at least one or more of the following:
1) method data associated with a method for calculating a state benefit;
2) low benefit amount data associated with a low benefit amount as a fraction of salary;
3) high benefit amount data associated with a high benefit amount as a fraction of salary;
4) minimum benefit amount data associated with a minimum state benefit amount; and
5) maximum benefit amount data associated with a maximum state benefit amount;
calculating state average fractional benefit data based on the accessed state benefit data; and
calculating state benefit amount data based on the calculated state average fractional benefit data, the annual salary data and the maximum state benefit amount data.

15. The system of claim 14, wherein the method further comprises:
calculating government unemployment contribution amount data based on the calculated state benefit amount data, the annual salary data and the coverage level data.

16. The system of claim 15, wherein the method further comprises:
calculating conversion factor data associated with a conversion factor, based on the annuity factor data, the coverage level data and the calculated government unemployment contribution amount data, wherein
the step of calculating the claim cost data is further based on the calculated conversion factor data.

17. The system of claim 15, wherein the method further comprises:
calculating benefit amount data based on the salary data, the coverage level data and the government unemployment contribution amount data.

18. The system of claim 17, wherein, upon the condition that the waiver selection data indicates that a waiver benefit is applicable, the method further comprises:
calculating additional cost data based on the calculated benefit amount data and the calculated premium payment data;
calculating premium multiplier data based on the additional cost data; and
re-calculating the premium payment data based on the original calculated premium payment data and the premium multiplier.

19. The system of claim 11, wherein the method further comprises:
receiving, by the computer system, request data associated with a request by at least one of the one or more beneficiaries for a supplemental unemployment insurance benefit under the group unemployment insurance policy; and
determining, by the computer system, eligibility of the at least one of the one or more beneficiaries for receipt of the supplemental unemployment insurance benefit.

20. The system of claim 19, wherein the step of determining eligibility is based on whether a state has determined that the at least one of the one or more beneficiaries is eligible for a state unemployment insurance benefit.
